(19) United States
(12) Patent Application Publication
(10) Pub. No.: US 2024/0281235 A1
(43) Pub. Date: Aug. 22, 2024

(54) TEMPORARILY ENABLING USE OF AN OPERATION FOR ACCESS AT AN ELECTRONIC DEVICE WHILE A PRECONDITION SPECIFICALLY ASSOCIATED WITH THE OPERATION IS SATISFIED, AND SYSTEMS AND METHODS OF USE THEREOF

(71) Applicant: Meta Platforms Technologies, LLC, Menlo Park, CA (US)

(72) Inventors: Willy Huang, San Francisco, CA (US); Sabrina Ylan Vogeley, Redwood City, CA (US); Yuxiao Tan, Chestnut Hill, MA (US); Nicolas Ramirez, Brooklyn, NY (US)

(21) Appl. No.: 18/584,904

(22) Filed: Feb. 22, 2024

Related U.S. Application Data
(60) Provisional application No. 63/486,445, filed on Feb. 22, 2023.

(51) Int. Cl. G06F 8/61; G06F 1/16; G06F 3/01; G06F 21/32; G06K 19/06; G06K 19/07

(52) U.S. Cl. CPC G06F 8/62; G06F 1/163; G06F 3/017; G06F 21/32; G06K 19/06037; G06K 19/0723

(57) ABSTRACT

Systems and methods are provided for temporarily enabling use of an operation for access at a wrist-wearable device (e.g., a smart watch). A method includes installing, on a wrist-wearable device worn by a user, data to enable use of an operation on the wrist-wearable device only while an operation-use precondition is present, where the operation-use precondition is specifically associated with the operation. The method further includes, while the operation-use precondition is present, enabling use of the operation on the wrist-wearable device. And the method further includes, in accordance with determining that the operation-use precondition is no longer present, removing at least some of the data from the wrist-wearable device to make the operation unavailable on the wrist-wearable device.

### CROSS-REFERENCE TO RELATED APPLICATIONS

This application claims priority to U.S. Prov. App. No. 63/486,445, filed on Feb. 22, 2023, and entitled “Temporarily Enabling Use Of An Operation For Access At An Electronic Device While A Precondition Specifically Associated With The Operation Is Satisfied, And Systems And Methods Of Use Thereof,” which is incorporated herein by reference.

### TECHNICAL FIELD

This disclosure relates generally to enabling operations of electronic devices, including but not limited to temporarily enabling operations (e.g., also referred to as ephemeral smartwatch experiences, or mini apps) that are caused to be installed or otherwise provided for use at the electronic devices (e.g., wrist-wearable devices) only while an operation-use precondition specifically associated with the operation is satisfied, and subsequently uninstalling at least some of the installed data associated with the operation once the operation-use precondition is no longer satisfied.

### BACKGROUND

Applications for mobile devices are becoming more popular, including applications that are integrated with activities that users perform in the physical world. However, some mobile devices (e.g., wearable devices such as wrist-wearable devices and head-wearable devices) have relatively limited storage and/or battery life, and therefore provisioning and usage of such applications requires access to precious resources.

Further, downloading software applications, and/or creating user accounts to authenticate the user of the mobile device, is tedious, time-consuming, and requires the user to provide access to potentially sensitive information that the user may wish to protect. And further still, before downloading software, users need to determine which applications are required to provide the functionality required for a particular activity. Once a user has identified an appropriate application to download for a particular situation, the user must use a wired or wireless internet connection to download the application, which may include data that is extraneous to the user's needs at that particular time.

As such, there is a need to address one or more of the above-identified challenges. A brief summary of solutions to the issues noted above is found below.

### SUMMARY

The methods, systems, and devices described herein allow electronic devices to install data to enable one or more operations while an operation-use precondition is satisfied, which can in some embodiments enable an ephemeral or time-limited smartwatch experience to facilitate efficient use of limiting computing, memory, and power resources for wearable devices (as one example). As a hypothetical example, a smartwatch user, Madeline, may be walking down the sidewalk past one of her favorite restaurants, Trendy Ramen Shop. Madeline knows there is usually a long waitlist to dine at Trendy Ramen Shop. And she doesn't want to install an entire application onto her smartwatch, which may have limited resources (e.g., available storage or connectivity) to be able to join a waitlist for Trendy Ramen Shop. As Madeline approaches the restaurant, a notification surfaces on the display of her smartwatch, indicating that data is being installed at the smartwatch that enables certain waitlist operations of an application for joining the waitlist for the restaurant. Madeline performs a thumbs-up gesture to confirm the installation of the data. But the data may have been automatically downloaded either way, based on the configuration settings of the smartwatch, particularly if the data requires a minimal amount of memory. The notification surfaced because Madeline was within a certain distance of Trendy Ramen Shop while wearing the smartwatch. And when either of those preconditions is no longer present (e.g., a location-based precondition, a biometric-authentication precondition), the enabled operations of the application may be automatically removed or otherwise disabled at the smartwatch.

In other situations, similar installation techniques can occur when Madeline engages in other activities, like shopping or attending a concert. For example, when she arrives at a concert or other limited-access event, a first set of operations may be installed that enable authentication operations for entering the venue. And subsequently, other sets of data associated with other sets of operations may be installed at a later time that enable additional functionality, such as obtaining food from a vendor within the venue (e.g., a snack shop). The techniques can be provided at other types of electronic devices besides smartwatches, such as artificial-reality (AR) headsets, or even a device constellation that includes a plurality of different electronic devices that are in electronic communication with one another, such as a system where a user is wearing a smartwatch and an AR headset, both of which are offloading processing to a portable computing unit separate from one or both of the wearable electronic devices.

The methods provide quick, efficient, intuitive, and resource-preserving technical improvements for limiting the amount of data installed on an electronic device and controlling access to operations (e.g., via biometric authentication based on a user wearing the device). But a person of skill in the art, upon reading the detailed description in conjunction with the figures provided herein will appreciate other technical improvements not explicitly described herein, such as an improved framework for managing settings like concerts or sporting events where a plurality of different vendors can be associated with a plurality of different applications. For example, the methods described herein may be used in conjunction with a framework for quickly and efficiently implementing intuitive adapters that application designers can use to integrate a subset of operations and/or functionality of a particular application with the framework, wherein the adapter can be configured to recognize one or more of a global set of operation-use conditions (e.g., a biometric authentication that requires a user to continue wearing a wearable device that includes a sensor for performing the biometric authentication).

One example method for using the systems, devices, non-transitory computer-readable storage media, and related techniques is described herein. This example method may be performed by a wrist-wearable device (e.g., a smartwatch) that includes one or more cameras, one or more displays (e.g., placed behind one or more lenses), and one or more programs, where the one or more programs are stored in memory and configured to be executed by one or more processors. The one or more programs include instructions for performing operations. The method includes installing, on the wrist-wearable device, data to enable use of an operation on the wrist-wearable device only while an operation-use precondition is present, where the operation-use precondition is specifically associated with the operation. The method further includes, while the operation-use precondition is present, enabling use of the operation on the wrist-wearable device. The method further includes, in accordance with determining that the operation-use precondition is no longer present, automatically, without instructions from the user of the wrist-wearable device (e.g., the user does not affirmatively make a request to remove any data related to the operation; instead, this can occur as a background process that is monitored based on presence or absence of the operation-use precondition), removing at least some of the data from the wrist-wearable device to make the operation unavailable. Several representative examples are shown in the sequences of FIGS. 1A-2M.

In some embodiments, a computing device (e.g., a wrist-wearable device or a head-mounted device, or an intermediary device such as a smartphone or desktop or laptop computer) includes one or more processors, memory, a display (in some embodiments, the display can be optional, such as for certain example intermediary devices that can coordinate operations at the wrist-wearable device and the head-mounted device, and thus have ample processing and power resources, but need not have its own display), and one or more programs stored in the memory. The programs are configured for execution by the one or more processors. The one or more programs include instructions for performing (or causing the performance of) any of the methods described herein.

Thus, methods, systems, and computer-readable storage media are disclosed for temporarily installing data on a wearable device based on the satisfaction of an operation-use condition that is related to an application that is configured to be enabled by the installed data.

The features and advantages described in the specification are not necessarily all-inclusive and, in particular, certain additional features and advantages will be apparent to one of ordinary skill in the art through familiarization of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description section below, in conjunction with the following drawings in which like reference numerals refer to corresponding parts throughout the figures.

FIGS. 1A-1I show an example sequence of a user interacting with an operation based on an operation-use condition being present, in accordance with some embodiments.

FIGS. 2A-2M show another example sequence of a user interacting with an operation based on an operation-use condition being present, in accordance with some embodiments.

FIG. 3 illustrates a flow diagram of an example method of temporarily enabling use of an operation for access at a wrist-wearable device, in accordance with some embodiments.

FIGS. 4A and 4B illustrate example artificial-reality systems, in accordance with some embodiments.

FIGS. 5A and 5B illustrate an example wrist-wearable device, in accordance with some embodiments.

FIGS. 6A-6C illustrate example head-wearable devices, in accordance with some embodiments.

FIGS. 7A and 7B illustrate an example handheld intermediary processing device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of AR systems. Artificial-reality, as described herein, is any superimposed functionality and or sensory-detectable presentation provided by an AR system within a user's physical surroundings. Such artificial-reality content can include and/or represent virtual reality (VR), augmented reality, mixed AR (MAR), or some combination and/or variation of one of these. For example, a user can perform a swiping in-air hand gesture to cause a song to be skipped by a song-providing API (application programming interface) providing playback at, for example, a home speaker. In some embodiments of an AR system, ambient light (e.g., a live feed of the surrounding environment that a user would normally see) can be passed through a display element of a respective head-wearable device presenting aspects of the AR system. In some embodiments, ambient light can be passed through one or more respective aspects of the AR system (e.g., one or both lens displays of the AR system). For example, a visual user interface element (e.g., a notification user interface element) can be presented at the head-wearable device, and an amount of ambient light (e.g., 15%-50% of the ambient light) can be passed through the user interface element, such that the user can distinguish at least a portion of the physical environment over which the user interface element is being displayed.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

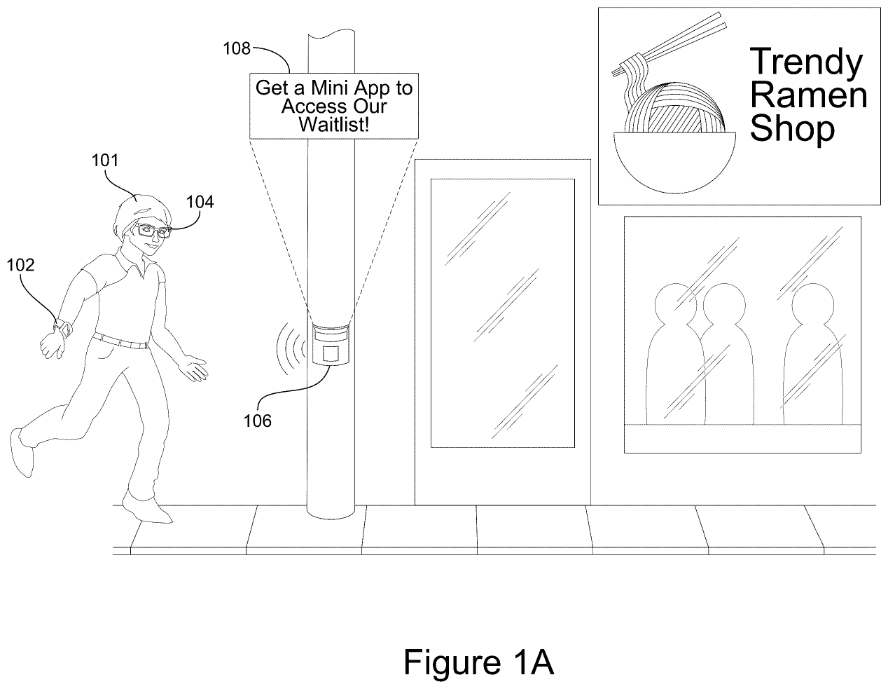

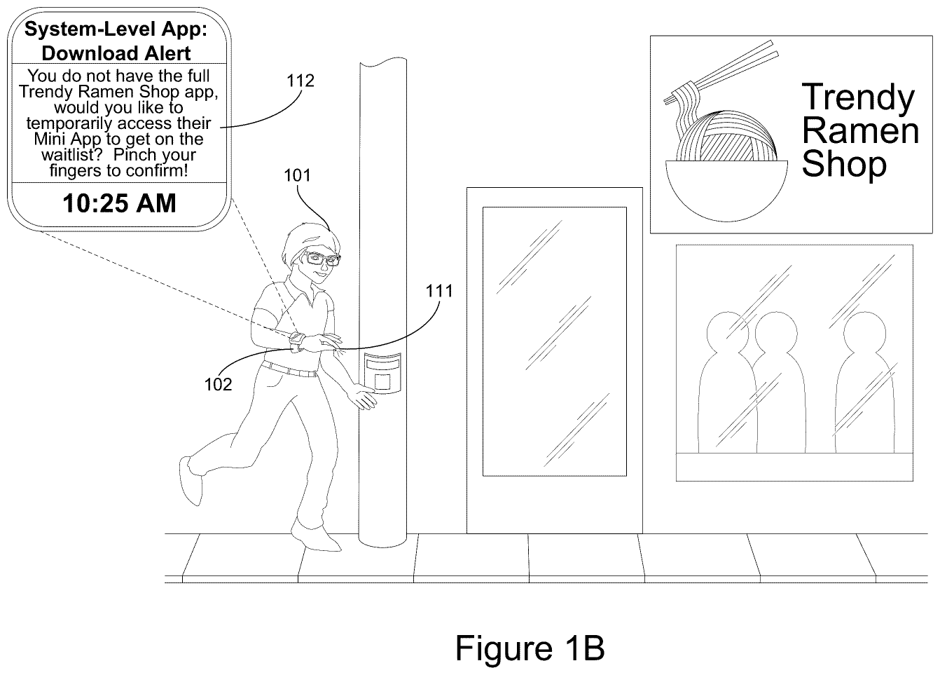

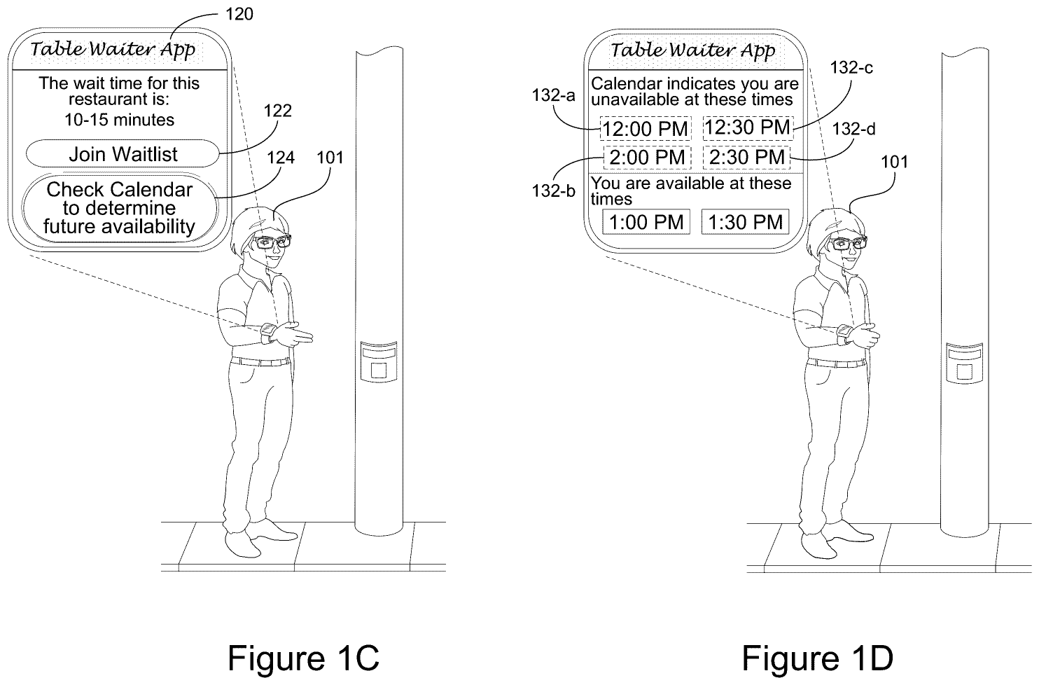

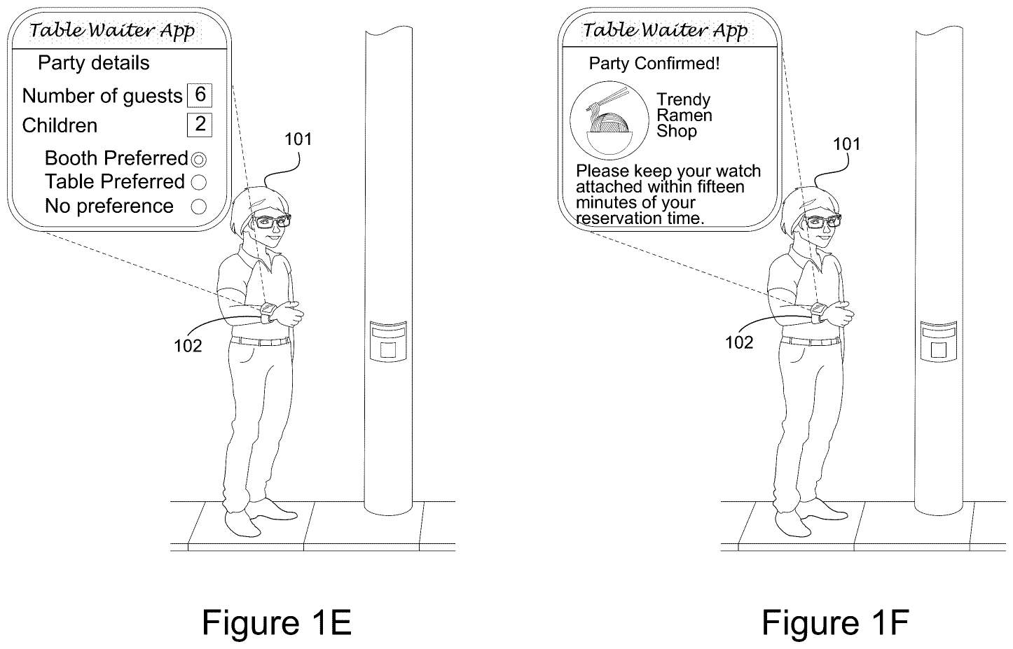

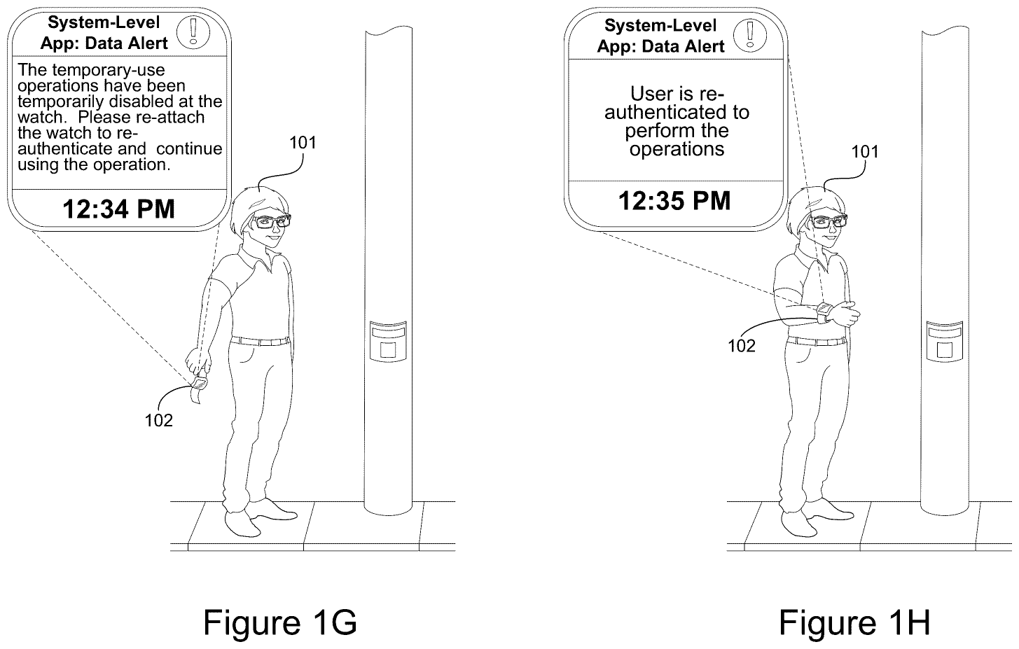

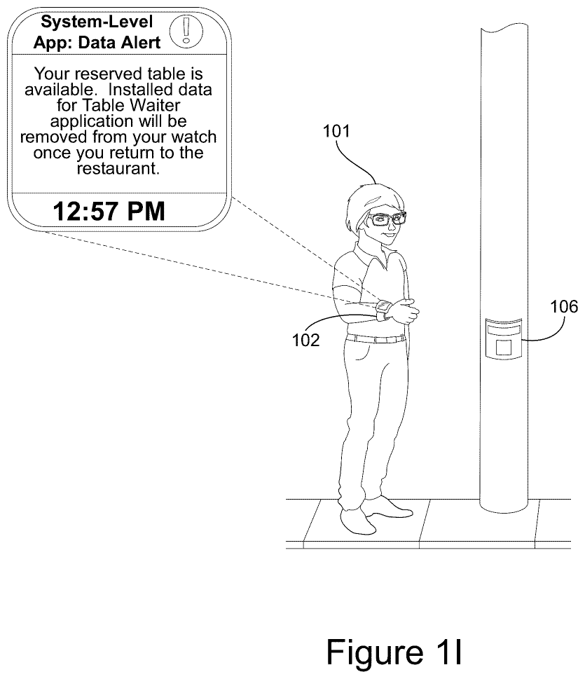

FIGS. 1A-1I show an example sequence of a user interacting with an operation based on an operation-use condition being present, in accordance with some embodiments. A user 101 is wearing a wrist-wearable device 102 (e.g., a smartwatch), and a head-wearable device 104 (e.g., an AR headset, and more specifically, augmented-reality glasses).

FIG. 1A shows the user 101 approaching a restaurant called Trendy Ramen Shop. There is a kiosk 106 located outside of the restaurant. A notification 108 is presented to the user 101 via the head-wearable device 104 indicating to the user 101 that data is available to be installed at the wrist-wearable device 102 (stating: “Get a Mini App to Access Our Waitlist!”) to enable use of an operation for allowing the user 101 to join the restaurant's waitlist. The notification being presented and the corresponding operations being available to the user 101 are based on several operation-use preconditions being satisfied at the particular time that the notification is presented. For example, a location-based precondition is present based on the user 101 being within a physical area associated with the restaurant (e.g., a threshold distance for using the operations to join the waitlist). Stated another way, the location-based precondition can be determined to be satisfied (which determination can be made by the wearable device, e.g., a module executing thereon) when the user is determined to be within the physical area, and the location-based precondition can be determined to not be satisfied when the opposite determination is made (e.g., user is determined to not be within the physical area). Thus, references to determinations of presence or absence of preconditions included herein should also be understood to refer to satisfying or failing to satisfy, respectively, the preconditions.

Additionally, a biometric-authentication precondition is determined to be present based on the authentication technique that requires the user 101 to be wearing the wrist-wearable device 102 (e.g., such that sensors of the wrist-wearable device 102 can detect biometric indications that can be used to identify the user 101). One of ordinary skill in the art will appreciate that the presence of any precondition or other criteria described herein can be determined based on one or more active logical determinations performed periodically (e.g., based on predefined polling criteria) and/or in response to a request regarding the particular precondition.

FIG. 1B shows the user 101 performing an in-air hand gesture 111, which causes data to enable one or more operations associated with the restaurant to be installed at the wrist-wearable device 102 (e.g., one or more operations for interacting with the waitlist of the restaurant). A notification user interface element 112 is displayed at the display of the wrist-wearable device, and the notification states: “You do not have the full Trendy Ramen Shop App, would you like to temporarily access their Mini App to get on the waitlist? Pinch your fingers to confirm!” That is, the notification user interface element 112 indicates that the user 101 does not already have the application associated with the operations that are enabled by the installed data.

FIG. 1C shows the wrist-wearable device performing an operation associated with the Table Waiter App, which is configured to allow users to add themselves to a waitlist at one or more restaurants (e.g., the Trendy Ramen Shop restaurant). The display of the wrist-wearable device 102 is displaying several user interface elements, including a visually-perceptible element (e.g., a top navigation bar logo) corresponding to the application (e.g., the Table Waiter App) that the enabled operations are related to. The visually-perceptible element may be presented despite the user 101 not having previously downloaded the application associated with the enabled operations at the wrist-wearable device 102, and the application not otherwise being available at the wrist-wearable device 102. For example, a logo user interface element 120 is displayed at the display of the wrist-wearable device 102 in conjunction with the display of the wrist-wearable device 102 presenting additional user interface elements based on the one or more operations that are enabled in accordance with the operation-use precondition being satisfied.

In some embodiments, the one or more operations associated with the Table Waiter App are caused to be enabled at the wrist-wearable device 102 despite the user 101 not having an account (e.g., a verified email address and corresponding password) associated with the Table Waiter App. In some embodiments, the one or more operations would only be enabled at the wrist-wearable device 102 based on the user 101 having an account associated with the Table Waiter App and having logged into the application with the account. That is, in some embodiments, the operation-use preconditions being satisfied can be an alternative (e.g., a proxy) to logging in with an account.

The user interface displayed at the display of the wrist-wearable device 102 in FIG. 1C includes selectable user interface elements that are configured to enable the user 101 to interact with the operations enabled at the wrist-wearable device 102 in accordance with the operation-use precondition being satisfied. A selectable user interface element 122 allows the user 101 to immediately join the waitlist for a restaurant (e.g., Trendy Ramen Shop) without any further instructions from the user.

The user 101 selecting a selectable user interface element 124 permits the one or more operations enabled in accordance with the operation-use precondition being satisfied to access data associated with a calendar application that the user 101 has previously installed at the wrist-wearable device 102 (e.g., including scheduled events that the user 101 has caused to be stored in memory of the wrist-wearable device 102). In some embodiments, the one or more operations enabled at the wrist-wearable device 102 correspond to a waitlist (e.g., a queue) for performing an activity at a physical area (e.g., Trendy Ramen Shop).

FIG. 1D shows a user interface being displayed at the display of the wrist-wearable device 102 based on the user 101 selecting the user interface element 124 in FIG. 1C to access the calendar application. Based on the user 101 selecting the user interface element 124 in FIG. 1C, the wrist-wearable device 102 permits access to scheduling data for the user 101, which allows for the operations to determine when the user 101 is available to join the waitlist associated with the restaurant. In some embodiments, the display of the wrist-wearable device can display an indication of one or more times that are unavailable for the user to perform the activity associated with the waitlist, based on scheduling data provided by the calendar application (e.g., notifications 132-a-132-d indicating times that the user 101 is not available based on data from the calendar application associated with the user 101). In some embodiments, the operations enabled by the operation-use precondition are provided in accordance with additional configuration settings allowing access to the user's scheduling data, where the additional configuration settings are generally for data installed based on an operation-use condition being present, and not specifically configured the application associated with the data being installed (the Table Waiter App).

FIG. 1E shows a user interface being displayed at the display of the wrist-wearable device based on the user 101 selecting a time for joining the waitlist based on the listing of available times of the user provided in FIG. 1D. In some embodiments, new data is installed at the wrist-wearable device 102 based on the user 101 performing operations that were enabled by the data that was previously installed based on the operations-use condition being present. For example, once the initially enabled operations at the wrist-wearable device are used by the user 101 to join the waitlist, the user 101 joining the waitlist can constitute a secondary operation-use precondition, causing secondary operations to be enabled at the wrist-wearable device 102 to allow the user 101 to perform additional operations to interact with the subset of functionality associated with the Table Waiter App.

FIG. 1F shows another user interface being displayed at the display of the wrist-wearable device 102 based on the user 101 finalizing their selections to join the waitlist at the restaurant. A user interface element is being presented at the display indicating to the user 101 to keep the wrist-wearable device 102 at a particular time based on the enabled operations (stating: “Please keep your watch attached within fifteen minutes of your reservation time.”). In some embodiments, the wrist-wearable device 102 can temporarily pause the enablement of the enabled operations during a predefined waiting period (e.g., a predefined fallback duration) during which no operations related to the operation-use precondition need to be enabled at the wrist-wearable device 102.

FIG. 1G shows the user 101 after they have removed the wrist-wearable device 102 such that it is no longer being worn on the wrist of the user 101. The display of the wrist-wearable device 102 is displaying a textual-prompt user interface element (stating: “The temporary-use operations have been temporarily disabled at the watch. Please re-attach the watch to re-authenticate and continue using the operation.”). In other words, the wrist-wearable device 102 is providing a notification to the user 101 that an operation-use precondition required for the one or more operations to be enabled at the wrist-wearable device 102 is no longer satisfied.

FIG. 1H shows the user 101 after re-donning the wrist-wearable device 102. Based on the user 101 re-donning the wrist-wearable device 102, the operations enabled by the operation-use condition being present are re-enabled at the wrist-wearable device. In some embodiments, the user can remove the wrist-wearable device 102 without causing the enabled operations to be disabled at the wrist-wearable device 102. In some embodiments, there is a predefined fallback duration during which the enabled operations will remain available at the wrist-wearable device 102, despite at least one of the operation-use preconditions not being satisfied (e.g., thirty seconds, five minutes, one hour). In some embodiments, the predefined fallback duration is based on the number of operation-use preconditions that are not satisfied at a given time.

FIG. 1I shows the user 101 standing by the kiosk 106 as they are entering the restaurant, and a notification is displayed at the display of the wrist-wearable device stating: “Your reserved table is available. Installed data for Table Waiter application will be removed from your watch once you return to the restaurant.” That is, an operation-use precondition of the data that was installed at the wrist-wearable device 102 can be that the user has not completed an activity associated with the enabled operations. In some embodiments, once the user 101 has completed an activity that the enabled operations are configured to perform or otherwise facilitate, some or all of the data that was installed based on the operation-use precondition can be uninstalled at the wrist-wearable device 102. In some embodiments, some of the data is kept (e.g., cached) or otherwise remembered by the wrist-wearable device 102 to make future installation processes easier. In some embodiments, the user 101 can be wearing another electronic device (e.g., a portable computing unit or a smartphone), and the data that is removed from the wrist-wearable device 102 can be relocated to the other electronic device.

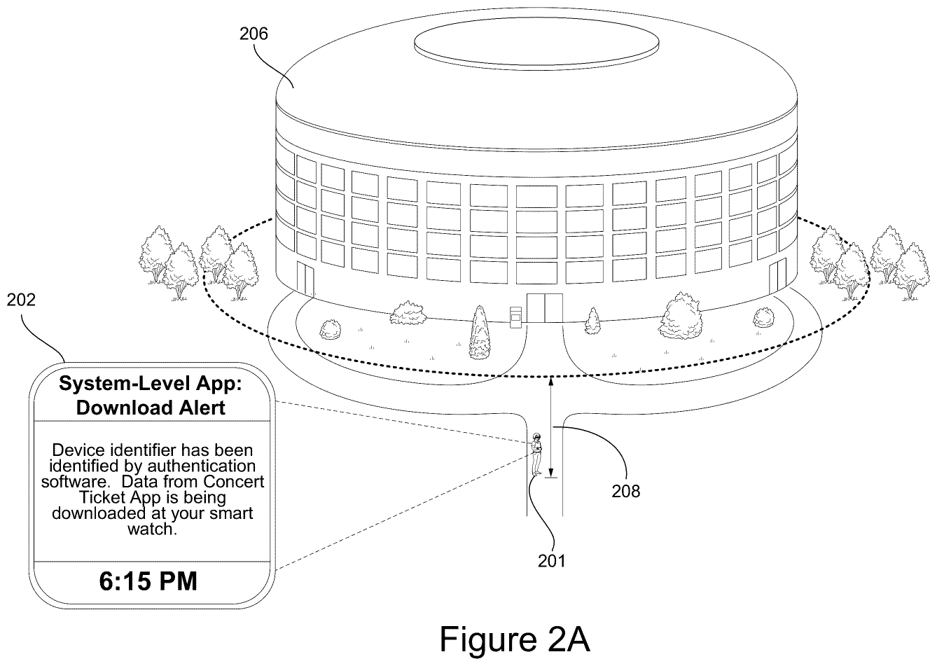

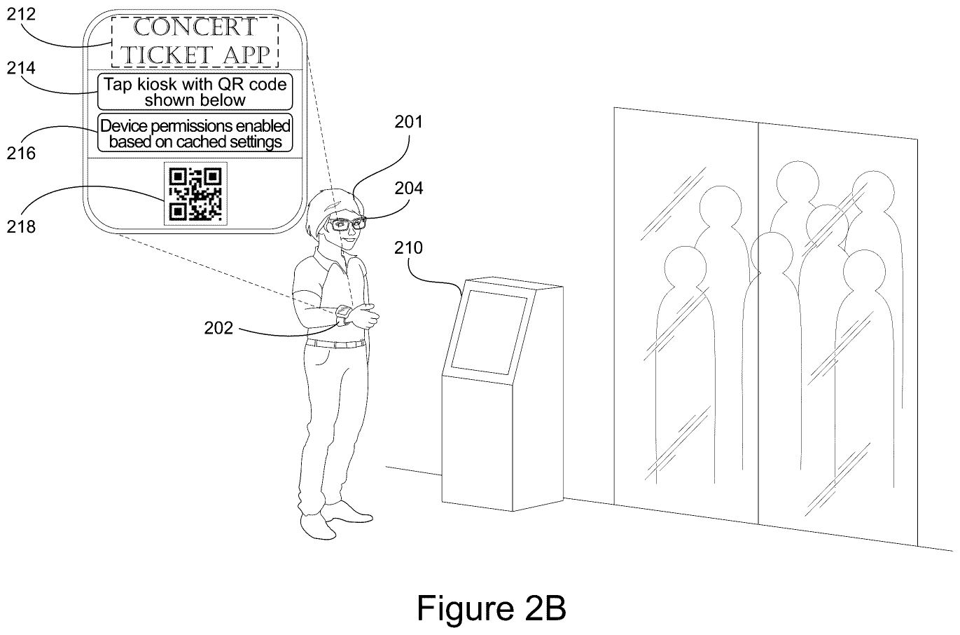

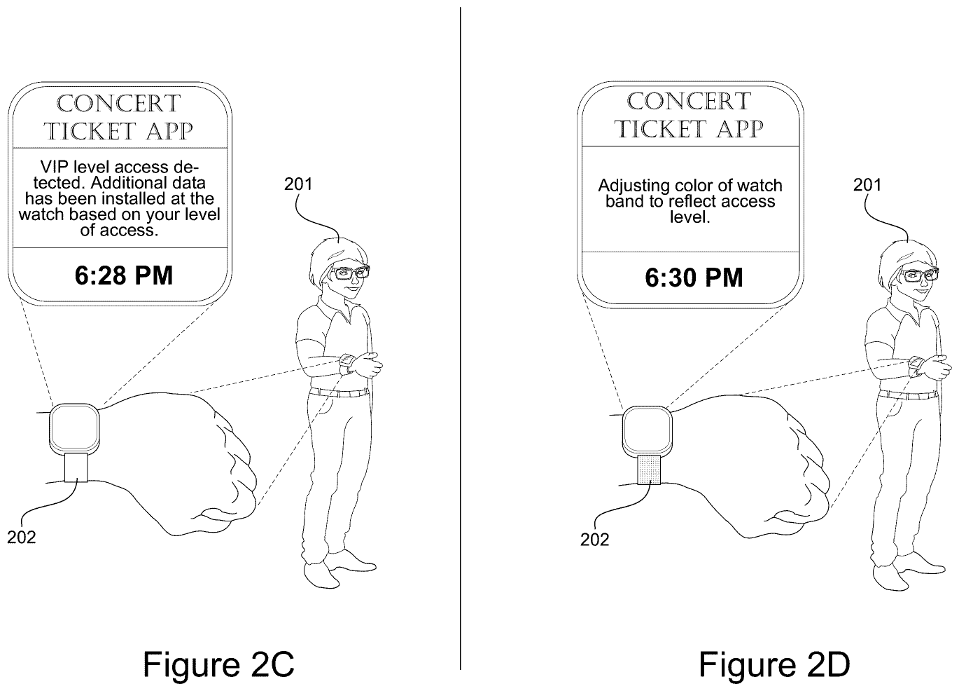

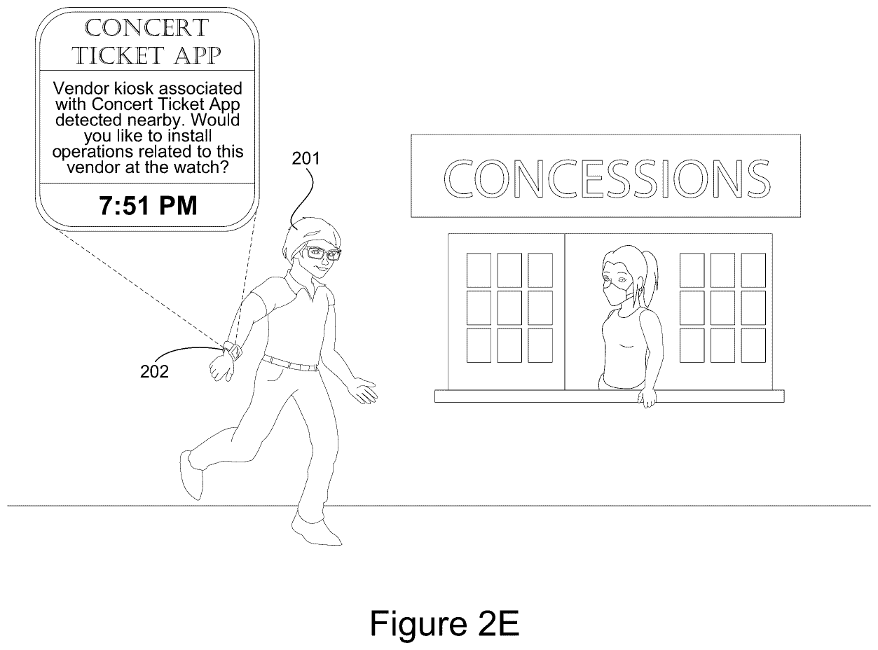

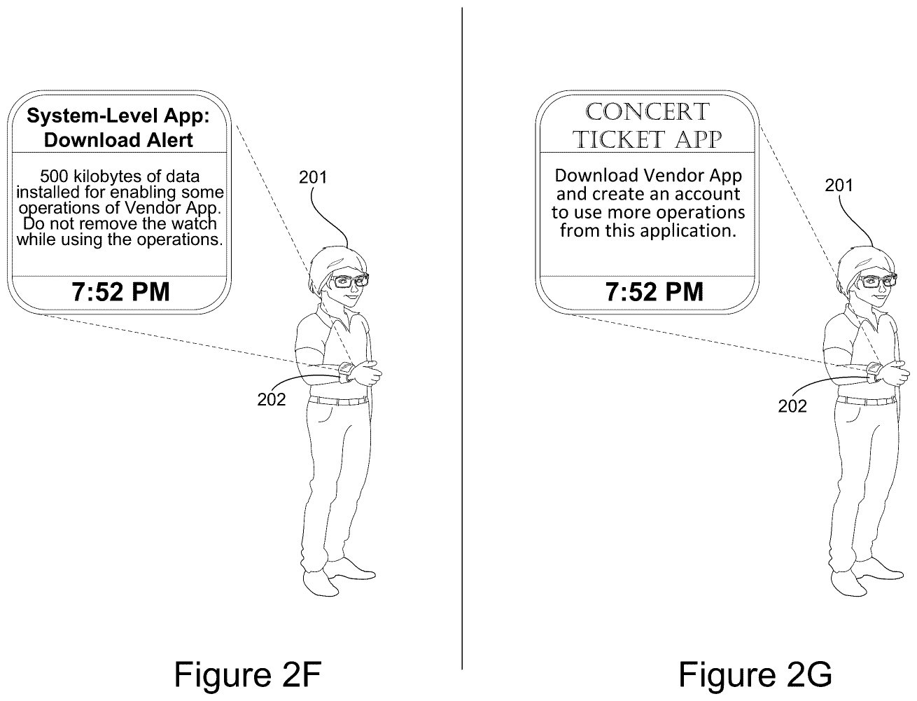

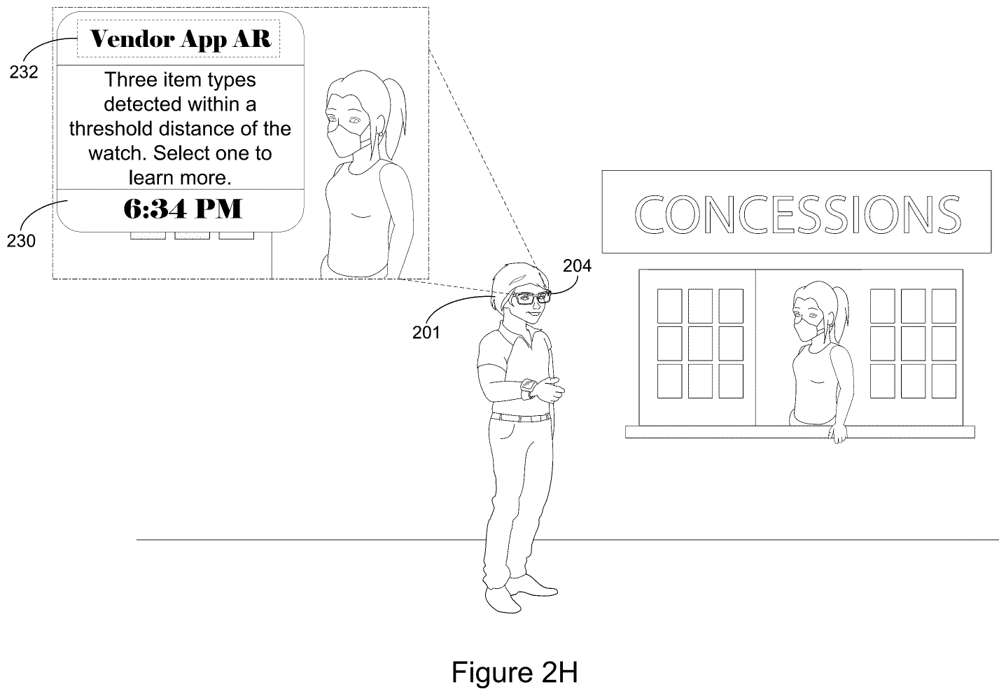

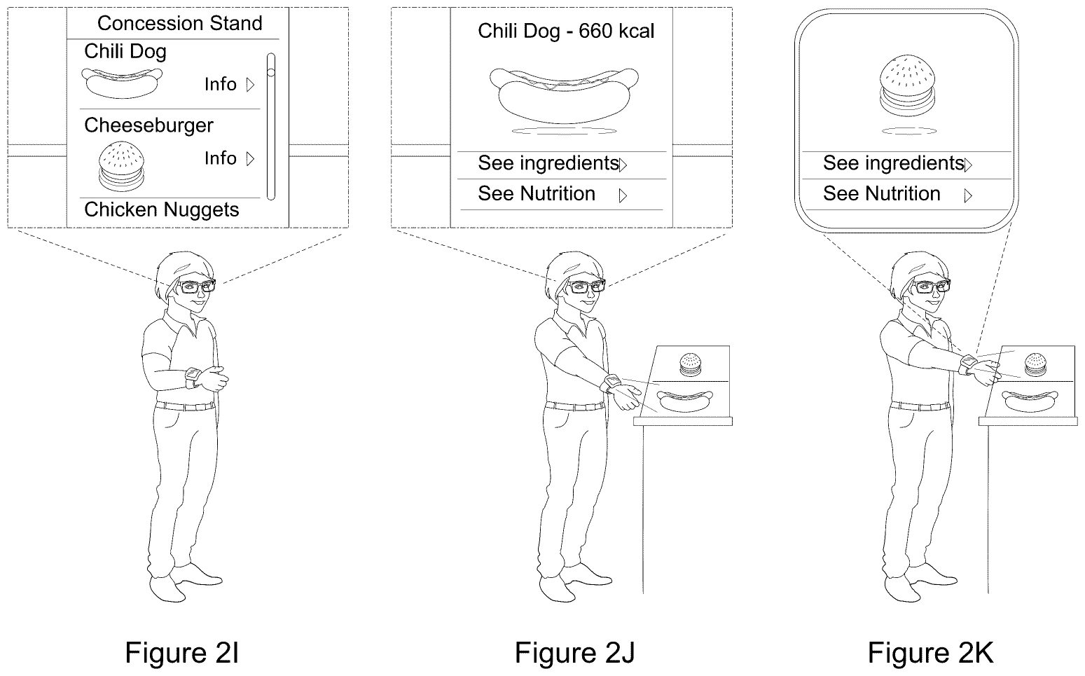

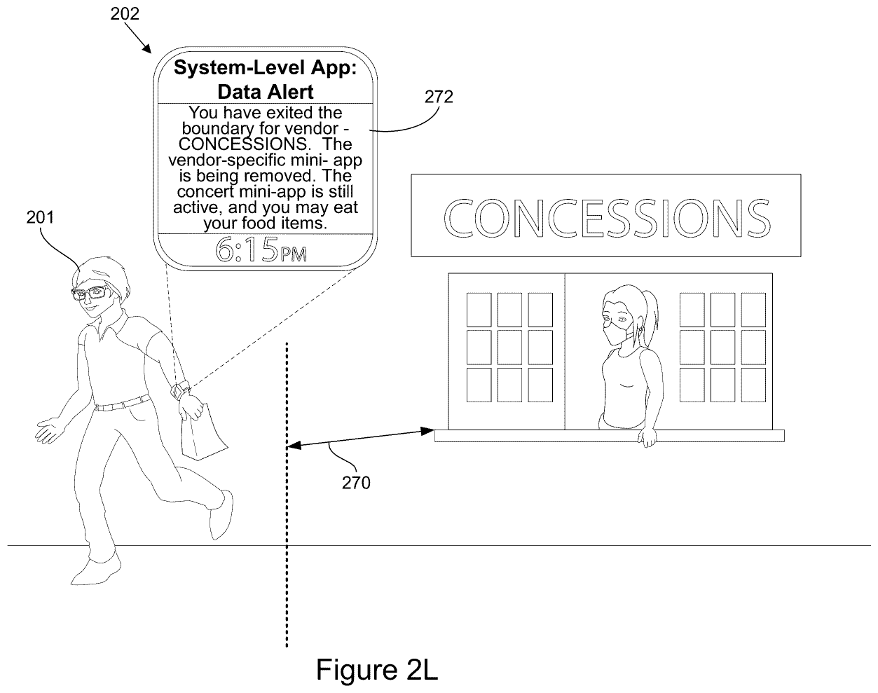

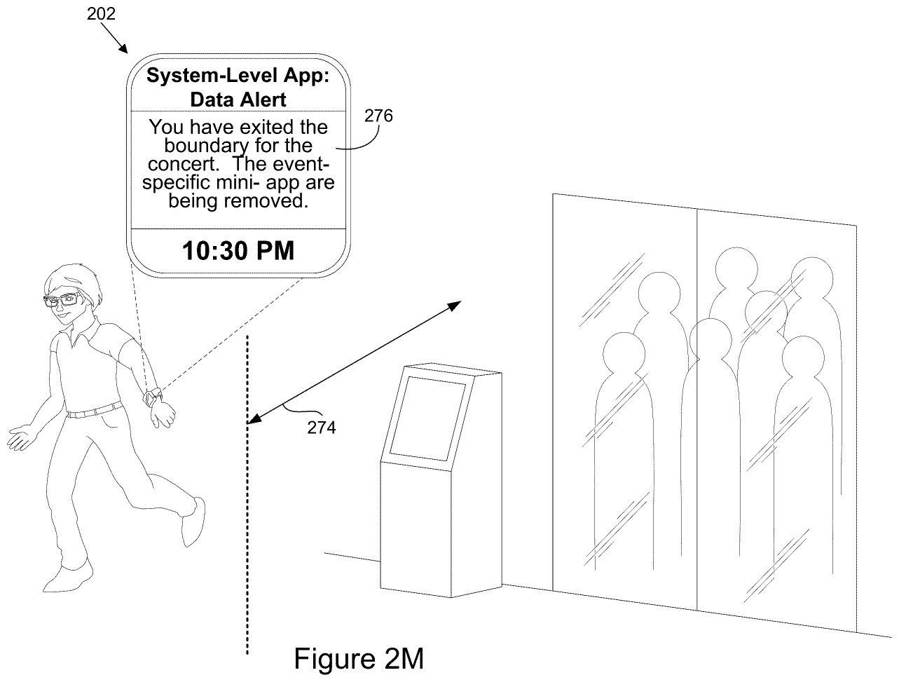

FIGS. 2A-2M show another example sequence of a user interacting with an operation based on an operation-use condition being present, in accordance with some embodiments. A user 201 is wearing a wrist-wearable device 202 (e.g., a smart watch) and a head-wearable device 204 (e.g., an AR headset, and more specifically, augmented-reality glasses).

FIG. 2A shows a user 201 that is wearing a wrist-wearable device 202 and a head-wearable device 204. The user 201 is arriving at a venue 206 associated with a limited-access event (e.g., a concert). A notification is displayed at the wrist-wearable device 202 stating: “Device identifier has been identified by venue authentication. Data from Concert Ticket App is being downloaded at your smart watch.” In other words, data (e.g., software components) associated with a ticketing application (e.g., the Concert Ticket App) is automatically being installed at the wrist-wearable device 202, without further instruction by the user 201, based on one or more operation-use preconditions (e.g., one or more criteria specifically related to the one or more operations that are enabled by the installed data) being satisfied. In this non-limiting example, a first operation-use precondition is a biometric-authentication precondition that is based on a biometric identifier of the user 201 detected, at least in part, by sensors that are located at the wrist-wearable device 202. In some embodiments, the biometric authentication precondition may be based on a biometric identifier of the user 201 that is detected by sensors of the head-wearable device 204. In some embodiments, the biometric identifier corresponding to the biometric-authentication precondition is persistently monitored by the wrist-wearable device 202 while the user 201 is attending the limited-access event. That is, while the user 201 is attending the limited-access event, the user 201 must continue to wear the wrist-wearable device 202 in order for the operation-use precondition to remain satisfied.

In some embodiments, the biometric-authentication precondition may remain satisfied despite the wrist-wearable device 202 being powered down (e.g., one or more sensors of the wrist-wearable device 202 may receive power independently from the power supplied to the wrist-wearable device 202).

Continuing the example illustrated by FIG. 2A, a second operation-use condition that is required for the data associated with the Concert Ticket App to be installed at the wrist-wearable device 202 is a location-based precondition (e.g., a precondition requiring the user to be within a predefined geofenced area). That is, the user 201 is required to be within a predefined distance 208 of the venue 206 in order for the second operation-use precondition to be satisfied.

Continuing the example, a third operation-use precondition is an operation-duration precondition defining a predetermined period when the data associated with the Concert Ticket App causes the one or more associated operations to be available to be installed (e.g., via data associated with an application) and/or used at the wrist-wearable device. For example, the operation-duration precondition may cause the one or more associated operations to be available for use from a predefined time 30 minutes before a start time of the limited access event to an end time 30 minutes after an end time of the limited access event.

FIG. 2B shows the user 201 standing near a kiosk 210 associated with a limited-access event. The wrist-wearable device is displaying a user interface element 212 that includes text stating “Concert Ticket App,” and the user interface element 212 includes a visually-perceptible element (e.g., a font type) of the application that is associated with the software that was installed at the wrist-wearable device 202.

The wrist-wearable device 202 displaying a textual-prompt user interface element 214 stating: “Tap kiosk with QR code shown below.” The wrist-wearable device is displaying an authentication display element 218 (e.g., a QR code) in conjunction with the textual-prompt user interface element 214 being displayed. The user interface element 214 is presented based on a secondary operation-use condition (e.g., a predefined threshold distance between the user 201 and the kiosk 210) being present after the operation-use preconditions cause the software to be installed at the wrist-wearable device 202 in FIG. 2A.

The wrist-wearable device 202 is displaying a user interface element 216 stating: “Device permissions enabled based on cached settings,” indicating that there are particular settings that have been previously enabled by the user 201 that allow the software that was installed at the wrist-wearable device 202 to access data required for an authentication technique related to the limited-access event to be performed (e.g., accessing additional identifying information of the user 201). In some embodiments, once software is installed at the wrist-wearable device 202 based on an operation-use precondition being present, and after the operation-use condition is no longer present at the wrist-wearable device 202, at least part of the software (e.g., application data) may remain at the wrist-wearable device. In this example, the user 201 has previously been in a situation where software related to the Concert Ticket App has been downloaded, and the user 201 has previously allowed permission-based access to the software associated with the Concert Ticket App. When the software was previously deleted, data related to the permission-based access was cached at the memory of the wrist-wearable device 202. In some embodiments, the data related to the software is cached at the wrist-wearable device 202 for a predefined period, and then deleted after the predefined period.

FIG. 2C shows the wrist-wearable device 202 displaying a notification stating: “VIP level access detected. Additional data has been installed at the watch based on your level of access,” which indicates that the user 201 has a particular level of access of a plurality of levels of access for the limited-access event. That is, once a particular operation-use precondition is present, thereby causing software to be installed at the wrist-wearable device 202, additional determinations may be made related to the operation-use precondition, such as determining which access level of a plurality of access levels the user is associated with for a limited-access event. In some embodiments, the additional data includes additional information about the limited-access event, and/or unlockable virtual objects (e.g., accessory items for animated avatars). In some embodiments, the virtual items are exclusively available to users who have the particular level of access (e.g., “VIP” level access) at the wrist-wearable device 202. In some embodiments, the additional software for the particular level of access relates to a real-world activity and/or additional convenience (e.g., a perk) related to the event.

FIG. 2D shows the wrist-wearable device 202 displaying a notification stating: “Adjusting color of wrist-wearable band to reflect access level.” The wrist-wearable device 202 may include several constituent components, such as a band portion, a housing portion configured to hold a display capsule component, and a capsule portion configured to be placed within the housing portion. In some embodiments, the band is configured to change to a particular color based on the level of access indicated by the software installed at the wrist-wearable device 202 based on the operation-use preconditions (discussed with respect to FIG. 2A) being present at the wrist-wearable device 202.

FIG. 2E shows the user approaching a concession stand within the venue associated with the limited-access event. The display of the wrist-wearable device 202 is presenting a notification stating: “Vendor kiosk associated with Concert Ticket App detected nearby. Would you like to install operations related to this vendor at the watch?” which indicates to the user 201 that additional software is available to be installed at the wrist-wearable device 202. In some embodiments, the software installed at the wrist-wearable device 202 based on the operation-use preconditions being present includes identifiers of secondary operation-use preconditions that can only be triggered while the software that was installed based on the initial operation-use preconditions is available. That is, installation of the additional software is contingent on the first data being installed based on the initial operation-use conditions being present.

FIG. 2F shows the display of the wrist-wearable device 202 displaying a notification related to additional software being installed at the wrist-wearable device 202. The notification includes a first textual element stating: “System-Level App: Download Alert,” which indicates that an operating-system-level application is performing the operations related to installing the software associated with the Vendor App. The notification includes a second textual element stating: “500 kilobytes of data installed for enabling some operations of Vendor App. Do not remove the watch while using the operations.”

FIG. 2G shows the display of the wrist-wearable device 202 displaying a notification stating: “Download Vendor App and create an account to use more operations from this application.” That is, in some embodiments the wrist-wearable device 202 can prompt the user 201 to install the entire application that is associated with the enabled operations. And using the application may require the user 201 to create an account associated with the application.

FIG. 2H shows a user interface 230 being presented at the AR headset 204 being worn by the user 201. The user interface 230 includes a visually-perceptible element 232 of an application (Vendor App AR) associated with the operations that were enabled by the data that was installed after the notification was provided in FIG. 2F.

FIGS. 2I-2K show user interface elements related to items that the user is able to purchase via the particular vendor for which the one or more secondary operations allow the user to interact with at the wrist-wearable device 202.

FIG. 2L shows the user 201 leaving the concession stand associated with the secondary data that was installed based on the secondary precondition related to the user 201 being within a location-based operation-use precondition of being within a threshold distance 270 of the concession stand while satisfying the original operation-use preconditions that allowed the first data to be installed related to the limited-access event. The display of the wrist-wearable device 202 is displaying a notification that the second data is being removed from the wrist-wearable device 202, stating: “You have exited the boundary for vendor—CONCESSIONS. The vendor-specific mini-app is being removed. The concert mini-app is still active, and you may eat your food items.”

FIG. 2M shows the user 201 exiting the venue 206 associated with the limited-access event that the operations enabled by the first data are related to. As the user 201 goes past the threshold distance 274 from the venue 206 corresponding to the location-based operation-use condition, the display of the wrist-wearable device 202 displays a notification user interface element 276 notifying the user 201 that the operations enabled by the first data are being removed from the wrist-wearable device 202, stating: “You have exited the boundary for the concert. The event-specific mini-app is being removed.”

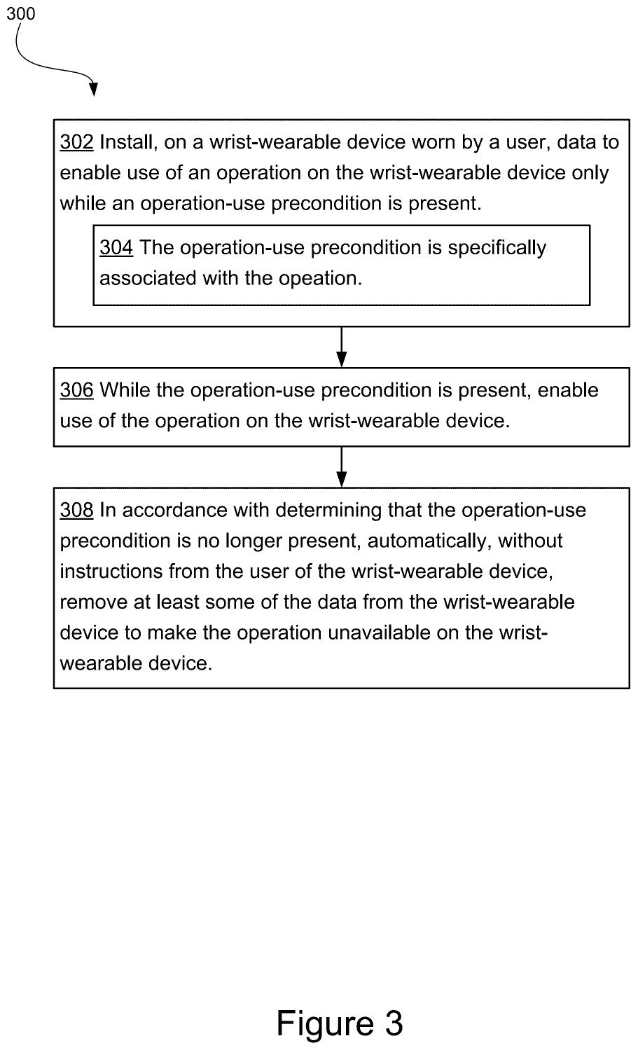

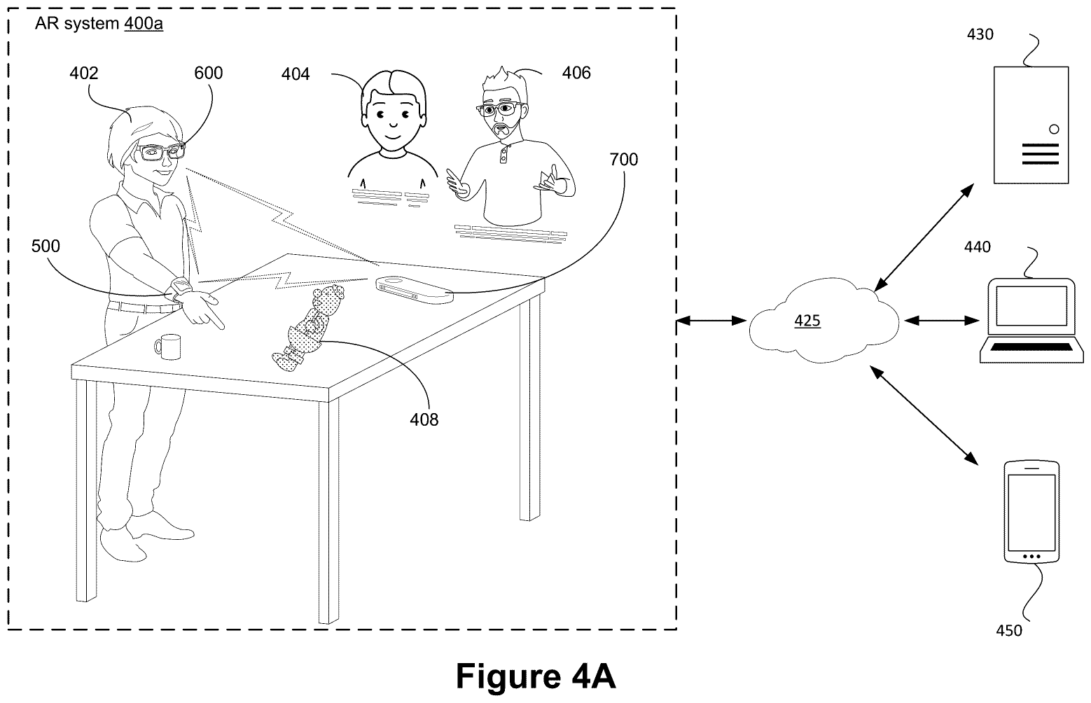

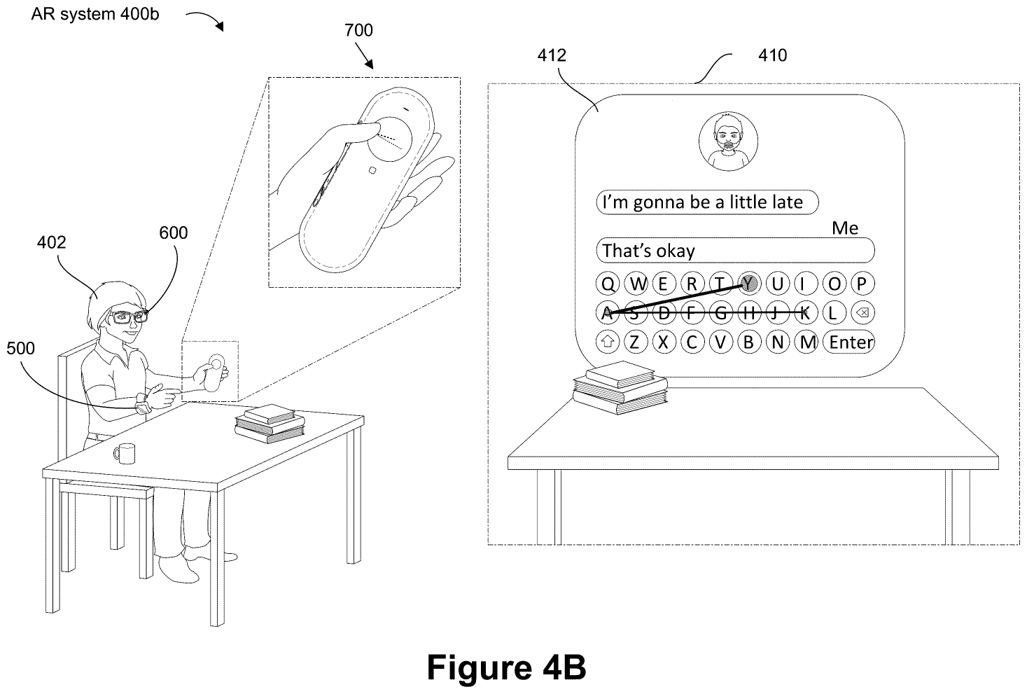

FIG. 3 illustrates a flow diagram of a method of temporarily enabling use of an operation for access at a wearable device, in accordance with some embodiments. Operations (e.g., steps) of the method 300 can be performed by one or more processors (e.g., central processing unit and/or MCU) of a wearable device (e.g., wrist-wearable device 102 and 202), or a system (e.g., a wearable device coupled with at least one other device described below in reference to FIGS. 4A and 4B). At least some of the operations shown in FIG. 3 correspond to instructions stored in a computer memory or computer-readable storage medium (e.g., storage, RAM, and/or memory). Operations of the method 300 can be performed by a single device alone or in conjunction with one or more processors and/or hardware components of another communicatively coupled device (e.g., the wrist-wearable device 102 and a handheld intermediary processing device 700 or a smartphone) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 3 shows a flow chart of a method 300 of temporarily enabling use of an operation for access at a wrist-wearable device, in accordance with some embodiments.

The method 300 includes installing (302), on a wrist-wearable device worn by a user, data to enable use of an operation on the wrist-wearable device only while an operation-use precondition is present (e.g., the user is still in line for a table at a restaurant, is still wearing the wrist-wearable device, and/or a predetermined period has not expired). The operation-use precondition is (304) specifically associated with the operation. Being specifically associated with the operation refers to, in some embodiments, the operation-use precondition not relating to general operating conditions of the wrist-wearable device (power level, memory availability, etc.) but instead relating to something specific to performance of the operation, such as being present within a specific area for performance of the activity (e.g., within a certain retail store) or being on a waitlist for accessing an activity and/or remaining within a certain proximity of a starting point of the activity (e.g., within a certain distance of a restaurant associated with the waitlist).

The method 300 includes, while (306) the operation-use precondition is present, enabling use of the operation on the wrist-wearable device. The method 300 includes, in accordance with determining (308) that the operation-use precondition is no longer present, automatically, without instructions from the user of the wrist-wearable device, removing at least some of the data from the wrist-wearable device to make the operation unavailable on the wrist-wearable device (e.g., is deleted, at least in part, from the user's electronic device). In some embodiments, at least some of the software is configured to remain at the wrist-wearable device (e.g., user data, receipts, code, or other instructions for installing software related to the subset of operations) when the one or more of the subset of operations is deleted).

(A2) In some embodiments of A1, the installation is initiated at the wrist-wearable device without any interaction by the user with a touch-sensitive display of the wrist-wearable device (e.g., user inputs directed to the touch-sensitive display). That is, the techniques described herein are distinct from selecting an application to install from an application store, since the installation that occurs via the described techniques can be automatically performed without any request from a user. For example, the Concert Ticket App in FIG. 2A may be automatically installed based on the user 201 being within a predefined distance threshold of the location of the limited-access event (e.g., the concert venue) while the user 201 is wearing the wrist-wearable device 202.

(A3) In some embodiments of any one of A1-A2, the operation-use precondition includes a biometric-authentication precondition requiring that the user be wearing the wrist-wearable device for the operation to remain enabled such that if the user is determined, based on operation-use condition data (e.g., sensor data) at the wrist-wearable device, to no longer be wearing the wrist-wearable device, then the operation-use precondition is no longer present (e.g., the user 201 is wearing the wrist-wearable device 202 in FIG. 2A to cause the operations associated with the Concert Ticket App to be installed at the wrist-wearable device 202).

In some embodiments, the operation-use precondition further includes one or more of (i) a duration precondition defining a predetermined period after the installation during which the operation is made available to the user, (ii) a physical activity-based precondition that is present while the user is performing a physical activity (e.g., in the physical world), the physical activity being specifically associated with the operation (e.g., shopping, waiting for dinner), and (iii) a location-based precondition that is present while the user is determined to be within a physical area associated with use of the operation (e.g., a geofenced area, a physically enclosed space, a vicinity associated with a limited-duration event). In some embodiments, a notification can be presented to the user to provide a time-limited duration to re-don the device before the data to enable use of the operation will be removed.

(A4) In some embodiments of any one of A1-A3, the installation is performed in response to detecting, via one or more sensors that are electronically coupled with (e.g., physically located at, in wireless communication with) the wrist-wearable device, a gesture (e.g., an in-air hand gesture detected by one or more neuromuscular-signal sensors) performed by the user (e.g., placing the electronic device within a threshold distance of the beacon for a predefined period) within a threshold distance of a physical beacon (e.g., a kiosk). In some embodiments, a plurality of physical beacons can be placed in various locations, with respective threshold proximities, which can overlap sometimes).

(A5) In some embodiments of any one of A1-A4, the installation is performed in response to one or both of (i) obtaining data from a QR code and (ii) obtaining data from a near-field communication (NFC) signal.

(A6) In some embodiments of any one of A1-A5, in conjunction with enabling use of the operation on the wrist-wearable device and in accordance with a determination that the operation requires image data, a camera that is in communication with the wrist-wearable device is activated. The method includes, while the operation-use precondition is present and the camera is activated, based on detecting, using image data from the camera, an identifier corresponding to a physical item (e.g., a tag attached to the item, a placard on a retail shelf that includes the item), causing display of data related to the physical item (e.g., point-of-sale data). In some embodiments, based on the detecting of the signal via the device identifier, a browser can be caused to be opened at the wrist-wearable device, where a webpage caused to be opened at the browser includes item data (e.g., average retail price, technical specifications, and/or customer reviews).

In some embodiments, the data related to the physical item can be caused to be displayed at a head-worn device (e.g., an AR headset), such as a pair of augmented-reality glasses (e.g., smart glasses). For example, the wrist-wearable device may send instructions to the AR glasses and/or another intermediate device and/or another facilitating device that may be configured to provide some instructions to the AR glasses.

In some embodiments, the identifier can be any physical characteristic of the physical item that allows an image-processing algorithm to detect and classify the physical item such that data about the physical item can be presented to the user (e.g., a menu allowing for selection of different action items for the physical item such as adding items to a shopping list, viewing calorie information, determining whether a particular physical item is defective (e.g., a particular fruit is rotten, an item is expired according to data associated with the item)).

In some embodiments, the wrist-wearable device can be configured to prompt the user to capture the image data based on the wrist-wearable device being unable to detect a device identifier of the physical item. That is, there can be an ordered heuristic for operations that can occur based on the user performing the second gesture, where the heuristic includes first checking for the device identifier of the physical item, which can be detected, for example, using NFC scanning, and next prompting the user to perform the camera operation if the device identifier is not detected within a certain proximity of the user (e.g., within one foot of the user).

(A7) In some embodiments of A6, the method 600 includes, while the data about the physical item is caused to be displayed, in accordance with determining that the user has provided a gesture-based indication or a location-based indication requesting to add the physical item to an item listing, adding the physical item to the item listing.

In some embodiments in which location-based indications are used to determine that an item is to be added to the item listing, the method includes, after detecting the identifier corresponding to the item, detecting that the user has moved to a second location, distinct from the first location (e.g., a different aisle, a different concert hall, a different amusement park ride), and detecting that the item is still within a threshold distance at the second location (e.g., within a threshold proximity of a location of a user's physical shopping cart and/or the user themself). That is, the user may have the item in their physical shopping cart or a bag that they are carrying within the area, and based on detecting that the item is still within the threshold proximity of the user at the second location, causing the item to be added to an item listing (e.g., a virtual shopping cart) associated with the user.

In some embodiments, data to enable use of the operation includes data to enable use of two or more respective operations associated with two or more distinct vendors (e.g., vendors of particular items that are present within the area). The method includes using a set of authentication techniques (e.g., one or more operating-system-level authentication techniques) to cause a first payment operation associated with a first vendor of the two or more distinct vendors (e.g., a payment operation). The method includes using the same set of authentication techniques to cause a second payment operation associated with a second vendor of the two or more distinct vendors. In some embodiments, the set of authentication techniques can be stored on the client device. In some embodiments, the wrist-wearable device checks or otherwise determines whether a particular software dependency (e.g., one or more non-transitory computer-readable storage media) is necessary for using the operation. In some embodiments, a set of operations to be performed at a location can be defined via an application programming interface (e.g., an API), and a plurality of compatible vendors can cause vendor-specific operations to occur, via an operation that corresponds to the API.

(A8) In some embodiments of A7, the method 300 includes, in accordance with determining that the operation-use precondition is no longer present, notifying the user that the operation is no longer available on the wrist-wearable device because the operation-use precondition is no longer present, and also notifying the user to retain physical possession of each physical item on the item listing (e.g., automatically purchase the items from the item listing). That is, the user can pay for each of the physical items using a payment method that can be associated with the wrist-wearable device.

(A9) In some embodiments of any one of A1-A8, the installation is performed in accordance with a determination that a component of the wrist-wearable device has been approved for access to a limited-access event by causing the wrist-wearable device to present an access information item (e.g., authentication information) to obtain access to the limited-access event. The data to enable use of the operation is associated with gaining access to the limited-access event by causing the wrist-wearable device to present information (e.g., access data, such as a scannable code (e.g., a QR code)) to obtain access to the limited-access event (e.g., a ticketed event, such as a concert, a sporting event, an amusement park, a festival). In some embodiments, the information to obtain access can be displayed (e.g., a scannable QR code) through an emitted signal modulated to include access-authentication information for the event. In some embodiments, the component of the wrist-wearable device can be a device identifier of a band portion, and/or a display capsule associated with the wrist-wearable device.

(A10) In some embodiments of A9, the access information item to obtain access to the limited-access event indicates one of a plurality of access levels (e.g., general access, VIP, performer) associated with the component of the wrist-wearable device. For example, a device identifier associated with the wrist-wearable device can indicate a level of the user's seating (e.g., fifteenth row, seat number 1504).

(A11) In some embodiments of any one of A1-A10, (i) the operation corresponds to a waitlist for performing an activity at a physical area (e.g., an establishment, a zoned location, a location associated with a social-media drop or other “flash” event), and (ii) without providing a phone number directly to an organizer of the activity, receive a message (e.g., an SMS and/or MMS text message, a message and/or notification from a social-media application), via the data to enable use of the operation, wherein the message is associated with a time for gaining access to the activity off the waitlist.

(A12) In some embodiments of A1-A11, the method includes, in conjunction with enabling use of the operation on the wrist-wearable device and in accordance with a determination that the operation requires scheduling data for the user, permitting access to data associated with a calendar operation, where a period (e.g., one or more acceptable time ranges based on the user's other scheduled activities) for gaining access to an activity corresponding to a waitlist is determined based in part on the scheduling data for the user. For example, the wrist-wearable device 102 in FIG. 1D has been permitted to access data from a calendar of the user 101 based on the user 101 selecting the selectable user interface element 124 in FIG. 1C.

(A13) In some embodiments of A1-A12, the method 600 includes, after installing the data to enable use of the operation, displaying, at the display of the wrist-wearable device, a visually-perceptible element (e.g., a look-and-feel, a logo) of an application corresponding to the operation, where the application is not otherwise available at the wrist-wearable device (e.g., the logo user-interface element 120 shown in FIG. 1C).

In some embodiments, the application corresponding to the operation is not downloaded at the wrist-wearable device. That is, the data to enable access to the operation allows for accessing a mini-application to gain access to an operation that is not otherwise available at the wrist-wearable device since the user has not elected to install the full-size application or because the full-size application is not compatible with executing on the wrist-wearable device (e.g., due to memory or bandwidth constraints).

(A14) In some embodiments of A1-A13, the operation corresponds to a third-party application (e.g., a third-party application associated with an establishment (e.g., a local restaurant, a chain retailer, a delivery service)), and the user is able to cause the operation to be performed without having an account associated with the third-party application. For example, the user interface displayed at the display of the wrist-wearable device 102 in FIG. 1C may be displayed even though the user 101 does not have an account that is associated with the Table Waiter App.

In some embodiments, the operation is configured to be performed at a front end (e.g., using a client-side set of instructions (e.g., JavaScript and/or React.js) of a user interface being presented by the wrist-wearable device). In some embodiments, the operation is installed without making a request to a server, or database at the wrist-wearable device or another electronic device. That is, no explicit requests for authentication are required to be made away from the front-end code corresponding to the enabled operation, which may be because the wrist-wearable device is authenticating the user based on being worn by the user.

(A15) In some embodiments of A1-A14, removing at least some of the data from the wrist-wearable device to make the operation unavailable on the wrist-wearable device includes removing all of the data from the wrist-wearable device. For example, the wrist-wearable device may perform system operations to ensure that all files and other data associated with the enabled operations are removed from the wrist-wearable device as part of the uninstalling operations.

(A16) In some embodiments of A1-A15, the data to enable use of an operation on the wrist-wearable device only while the operation-use precondition is present has an associated file size of less than one hundred megabytes (100 MB). For example, FIG. 2F shows the notification at the wrist-wearable device 202 indicating that the data associated with the Vendor App includes five hundred kilobytes (500 KB) of data.

(A17) In some embodiments of A16, the associated file size of the data to enable use of the operation on the wrist-wearable device is less than fifty megabytes (50 MB). In some embodiments, the associated file size of the data to enable use of the operation is less than ten megabytes (10 MB), one megabyte (1 MB), one hundred kilobytes (100 KB), ten kilobytes (10 KB), or a smaller value. In some embodiments, the amount of data installed at a user's electronic device based on the operation-used precondition being satisfied may be based on an amount of available storage at the user's electronic device, which may be based on an amount of storage that is allotted for data-enabling operations related to one or more operation-use preconditions. In some embodiments, when data-enabling operations related to operation-use preconditions are removed from a user's electronic device, some data may remain stored (e.g., cached) at the user's electronic device, assuming that sufficient storage is available.

In some embodiments, an antenna of the wrist-wearable device (e.g., a signal typically used for cellular connections with other users) is used to determine whether the user is within an area associated with the operation that is enabled by the installed data.

(B1) In accordance with some embodiments, a particular wrist-wearable device is provided, where the particular wrist-wearable device is configured to perform or cause performance of the method of any of A1-A17.

(B1) In accordance with some embodiments, a non-transitory computer-readable storage medium including instructions is provided. The non-transitory computer-readable storage medium is configured such that, when executed by a wearable device (e.g., a wrist-wearable device or a head-wearable device such as an artificial-reality headset or smart contact lenses), it can cause the wearable device to perform operations corresponding to any of A1-A17.

(C1) In accordance with some embodiments, a system that includes one or more wrist-wearable devices and an artificial-reality headset (which can include smart contact lenses) is provided (which system can also include an intermediary processing device configured to coordinate operations between the wrist-wearable devices and the AR headset), and the system is configured to perform operations corresponding to any of A1-A17. For example, the sequence described by FIGS. 2A-2M includes a user 201 that is wearing the wrist-wearable device 202 and the head-wearable device 204.

(D1) In accordance with some embodiments, a server system including one or more servers is provided, where the one or more servers include one or more processors and memory. And the memory stores instructions, which, when executed by the one or more processors of the server system, cause data to be received by one or more wrist-wearable devices (e.g., data to enable one or more operations related to one or more operation-use preconditions), where the data can enable the wrist-wearable device (e.g., the wrist-wearable device 102) to perform or cause performance of any of A1-A17.

(E1) In another aspect, means for performing each operation of any of A1-A17 are provided.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 500, a head-wearable device, an HIPD 700, a smart textile-based garment (not shown), or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

FIGS. 4A and 4B illustrate example artificial-reality systems, in accordance with some embodiments. FIG. 4A shows a first AR system 400a and first example user interactions using a wrist-wearable device 500, a head-wearable device (e.g., AR device 600), and/or a handheld intermediary processing device (HIPD) 700. FIG. 4B shows a second AR system 400b and second example user interactions using a wrist-wearable device 500, AR device 600, and/or an HIPD 700. As the skilled artisan will appreciate upon reading the descriptions provided herein, the above-example AR systems (described in detail below) can perform various functions and/or operations described above with reference to FIGS. 1A-3.

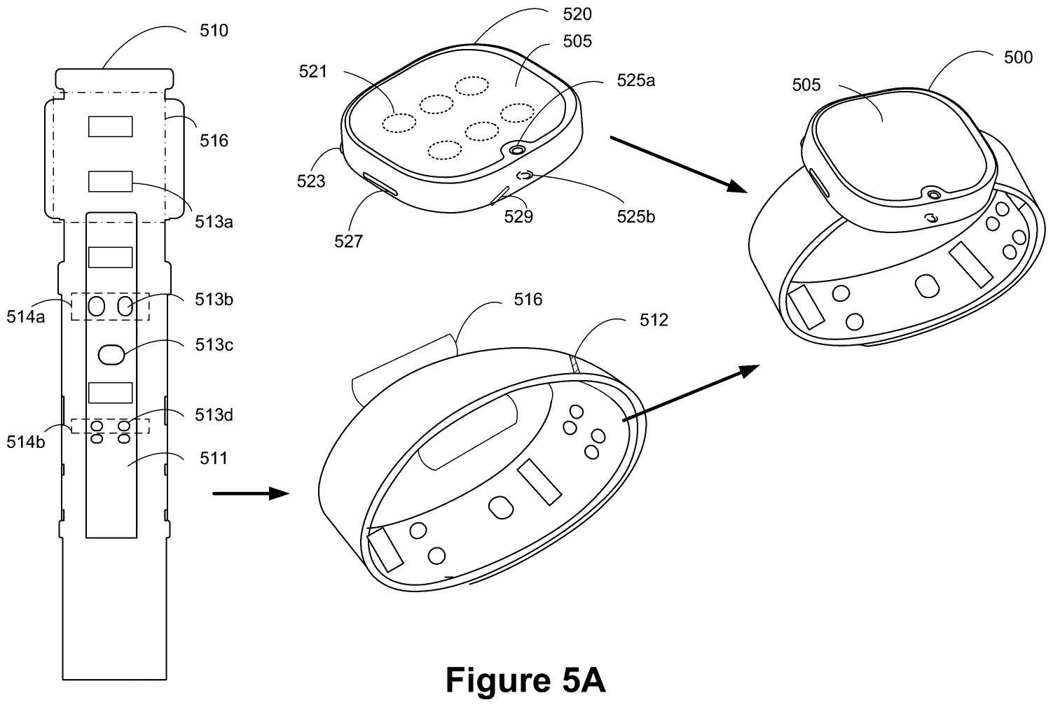

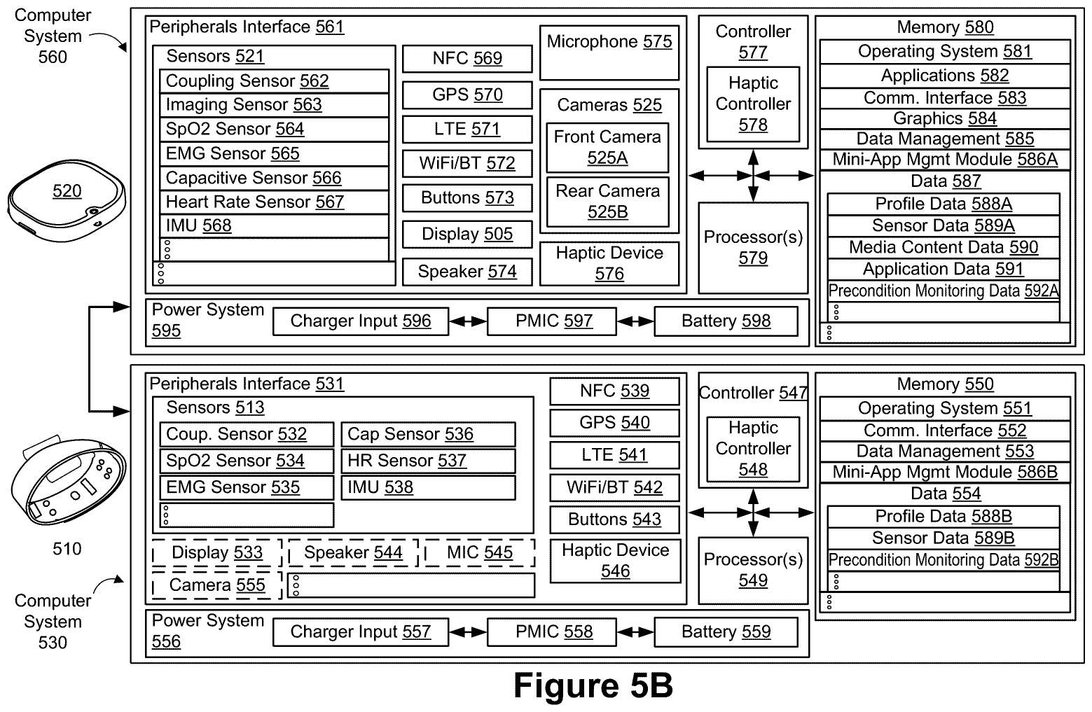

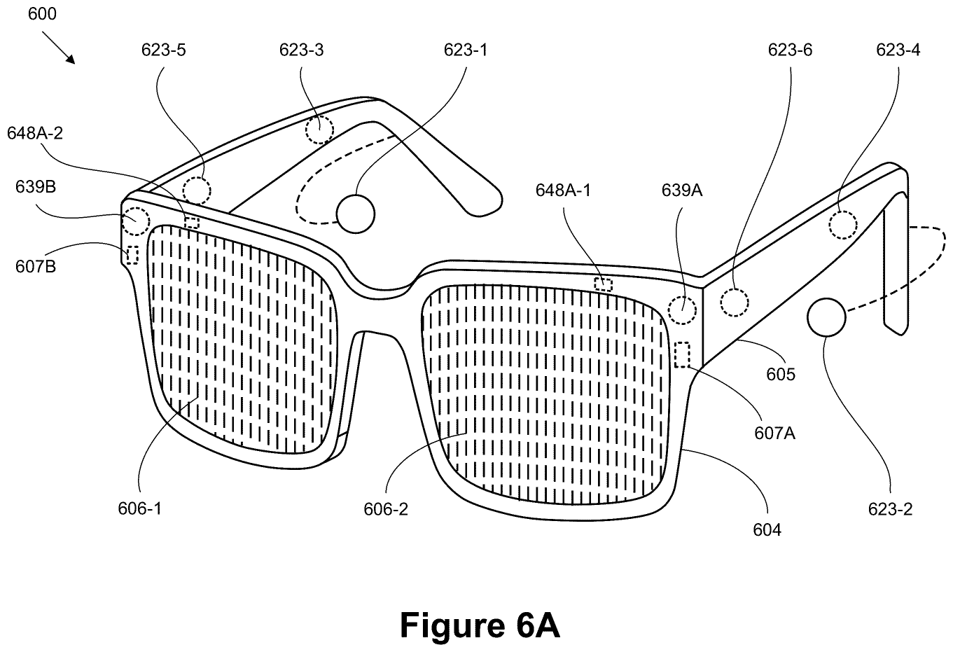

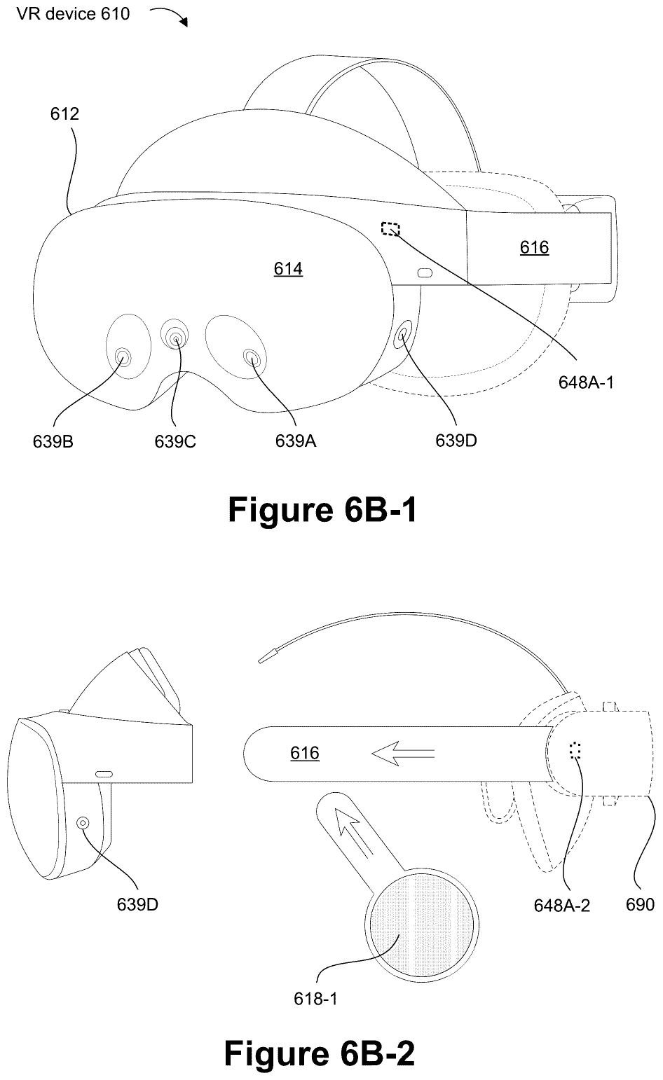

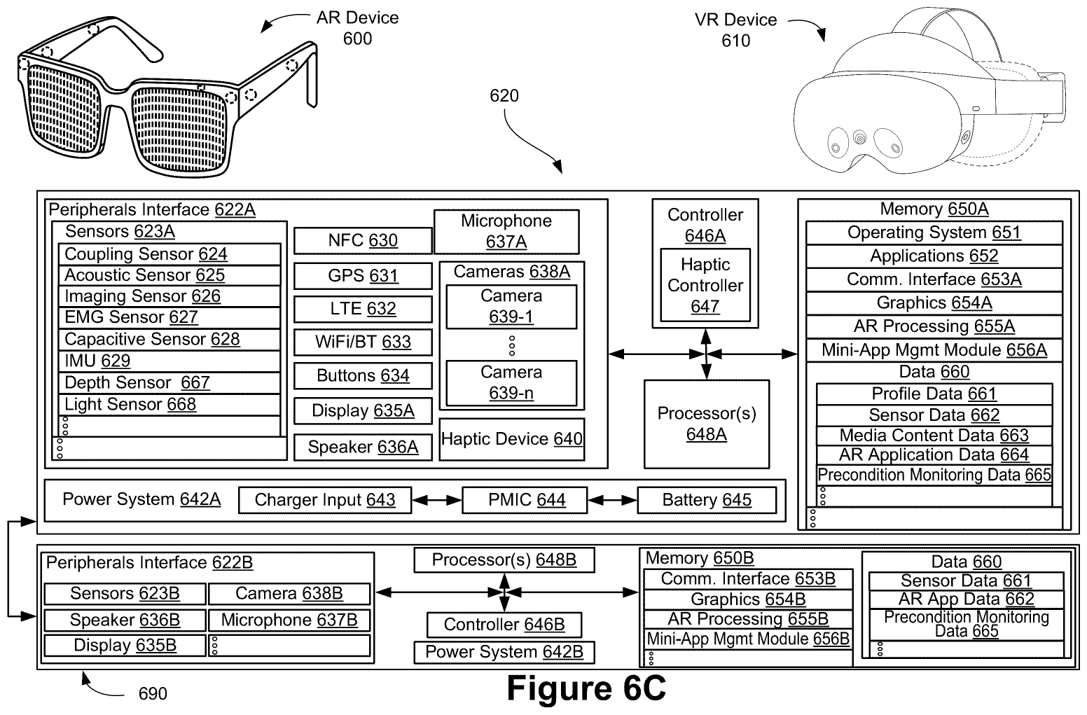

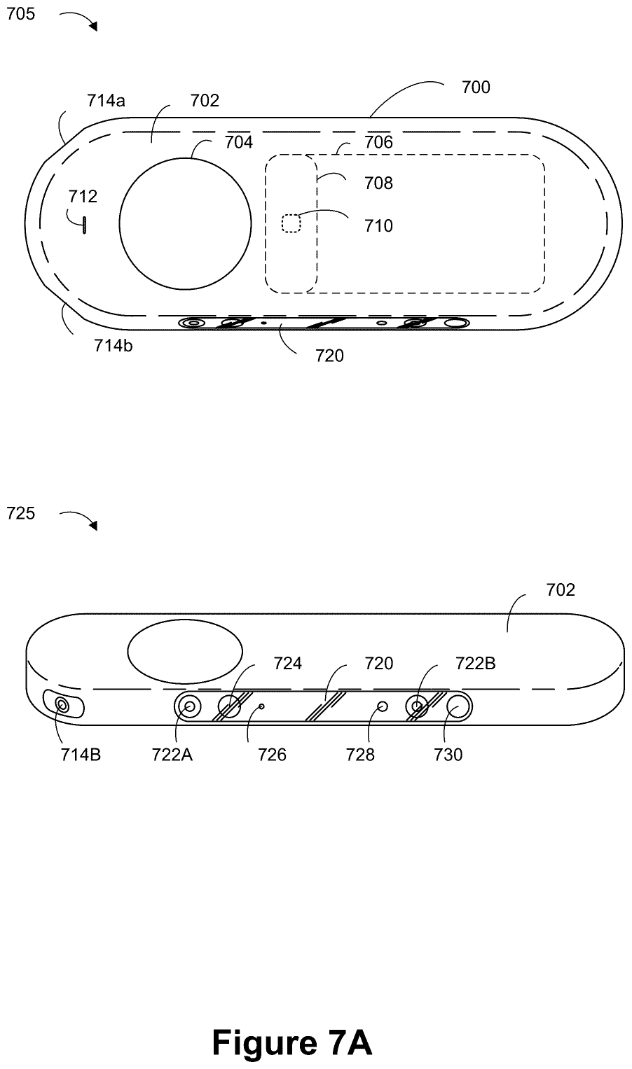

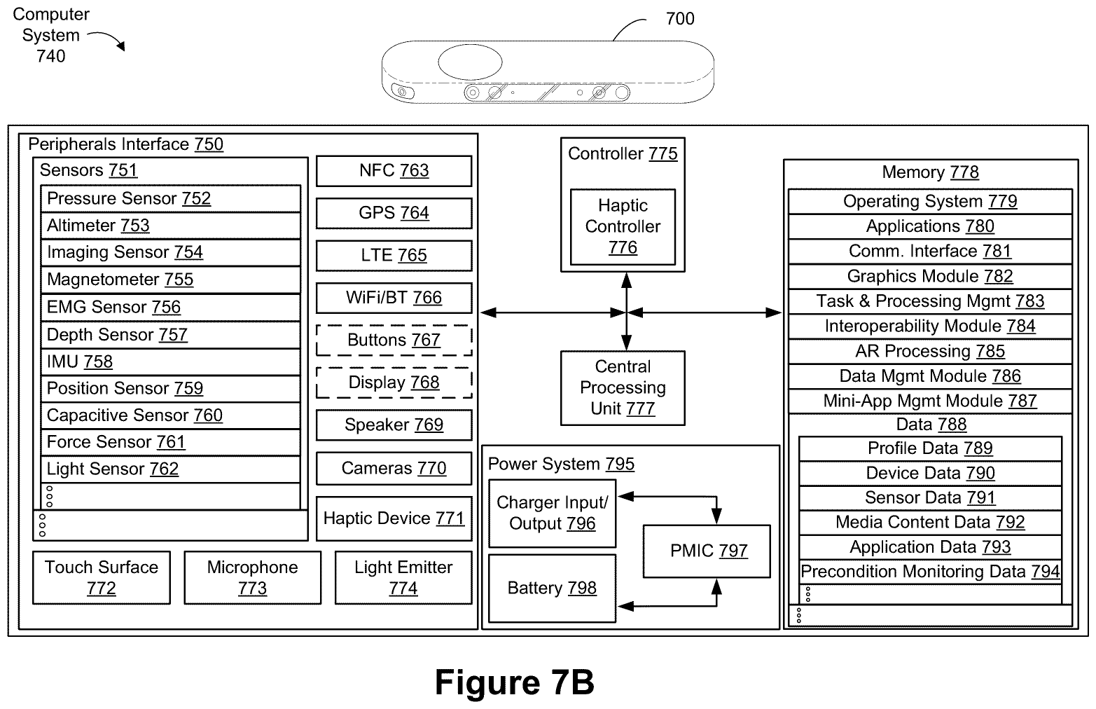

The wrist-wearable device 500 and its constituent components are described below in reference to FIGS. 5A-5B, the head-wearable devices and their constituent components are described below in reference to FIGS. 6A-6D, and the HIPD 700 and its constituent components are described below in reference to FIGS. 7A-7B. The wrist-wearable device 500, the head-wearable devices, and/or the HIPD 700 can communicatively couple via a network 425 (e.g., cellular, near field, Wi-Fi, personal area network, wireless LAN, etc.). Additionally, the wrist-wearable device 500, the head-wearable devices, and/or the HIPD 700 can also communicatively couple with one or more servers 430, computers 440 (e.g., laptops, computers, etc.), mobile devices 450 (e.g., smartphones, tablets, etc.), and/or other electronic devices via the network 425 (e.g., cellular, near field, Wi-Fi, personal area network, wireless LAN, etc.).

Turning to FIG. 4A, a user 402 is shown wearing the wrist-wearable device 500 and the AR device 600, and having the HIPD 700 on their desk. The wrist-wearable device 500, the AR device 600, and the HIPD 700 facilitate user interaction with an AR environment. In particular, as shown by the first AR system 400a, the wrist-wearable device 500, the AR device 600, and/or the HIPD 700 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 500, the AR device 600, and/or the HIPD 700.

The user 402 can use any of the wrist-wearable device 500, the AR device 600, and/or the HIPD 700 to provide user inputs. For example, the user 402 can perform one or more hand gestures that are detected by the wrist-wearable device 500 (e.g., using one or more EMG sensors and/or IMUs, described below in reference to FIGS. 5A-5B) and/or AR device 600 (e.g., using one or more image sensors or cameras, described below in reference to FIGS. 6A-6B) to provide a user input. Alternatively, or additionally, the user 402 can provide a user input via one or more touch surfaces of the wrist-wearable device 500, the AR device 600, and/or the HIPD 700, and/or voice commands captured by a microphone of the wrist-wearable device 500, the AR device 600, and/or the HIPD 700. In some embodiments, the wrist-wearable device 500, the AR device 600, and/or the HIPD 700 include a digital assistant to help the user in providing a user input (e.g., completing a sequence of operations, suggesting different operations or commands, providing reminders, confirming a command). In some embodiments, the user 402 can provide a user input via one or more facial gestures and/or facial expressions. For example, cameras of the wrist-wearable device 500, the AR device 600, and/or the HIPD 700 can track the user 402's eyes for navigating a user interface.

The wrist-wearable device 500, the AR device 600, and/or the HIPD 700 can operate alone or in conjunction to allow the user 402 to interact with the AR environment. In some embodiments, the HIPD 700 is configured to operate as a central hub or control center for the wrist-wearable device 500, the AR device 600, and/or another communicatively coupled device. For example, the user 402 can provide an input to interact with the AR environment at any of the wrist-wearable device 500, the AR device 600, and/or the HIPD 700, and the HIPD 700 can identify one or more back-end and front-end tasks to cause the performance of the requested interaction and distribute instructions to cause the performance of the one or more back-end and front-end tasks at the wrist-wearable device 500, the AR device 600, and/or the HIPD 700. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 7A-7B, the HIPD 700 can perform the back-end tasks and provide the wrist-wearable device 500 and/or the AR device 600 operational data corresponding to the performed back-end tasks such that the wrist-wearable device 500 and/or the AR device 600 can perform the front-end tasks. In this way, the HIPD 700, which has more computational resources and greater thermal headroom than the wrist-wearable device 500 and/or the AR device 600, performs computationally intensive tasks and reduces the computer resource utilization and/or power usage of the wrist-wearable device 500 and/or the AR device 600.

In the example shown by the first AR system 400a, the HIPD 700 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 700 performs back-end tasks for processing and/or rendering image data (and other data) associated with the AR video call and provides operational data associated with the performed back-end tasks to the AR device 600 such that the AR device 600 performs front-end tasks for presenting the AR video call (e.g., presenting the avatar 404 and the digital representation of the contact 406).

In some embodiments, the HIPD 700 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 700. In particular, the HIPD 700 and the AR device 600 operate in conjunction to determine a location for presenting the avatar 404 and the digital representation of the contact 406. In some embodiments, information can be presented within a predetermined distance from the HIPD 700 (e.g., within five meters). For example, as shown in the first AR system 400a, virtual object 408 is presented on the desk some distance from the HIPD 700. Similar to the above example, the HIPD 700 and the AR device 600 can operate in conjunction to determine a location for presenting the virtual object 408. Alternatively, in some embodiments, presentation of information is not bound by the HIPD 700. More specifically, the avatar 404, the digital representation of the contact 406, and the virtual object 408 do not have to be presented within a predetermined distance of the HIPD 700.

User inputs provided at the wrist-wearable device 500, the AR device 600, and/or the HIPD 700 are coordinated such that the user can use any device to initiate, continue, and/or complete an operation. For example, the user 402 can provide a user input to the AR device 600 to cause the AR device 600 to present the virtual object 408 and, while the virtual object 408 is presented by the AR device 600, the user 402 can provide one or more hand gestures via the wrist-wearable device 500 to interact and/or manipulate the virtual object 408.

FIG. 4B shows the user 402 wearing the wrist-wearable device 500 and the AR device 600, and holding the HIPD 700. In the second AR system 400b, the wrist-wearable device 500, the AR device 600, and/or the HIPD 700 are used to receive and/or provide one or more messages to a contact of the user 402. In particular, the wrist-wearable device 500, the AR device 600, and/or the HIPD 700 detect and coordinate one or more user inputs to initiate a messaging application and prepare a response to a received message via the messaging application.

In some embodiments, the user 402 initiates, via a user input, an application on the wrist-wearable device 500, the AR device 600, and/or the HIPD 700 that causes the application to initiate on at least one device. For example, in the second AR system 400b the user 402 performs a hand gesture associated with a command for initiating a messaging application (represented by messaging user interface 412); the wrist-wearable device 500 detects the hand gesture; and, based on a determination that the user 402 is wearing AR device 600, causes the AR device 600 to present a messaging user interface 412 of the messaging application. The AR device 600 can present the messaging user interface 412 to the user 402 via its display (e.g., as shown by user 402's field of view 410). In some embodiments, the application is initiated and can be run on the device (e.g., the wrist-wearable device 500, the AR device 600, and/or the HIPD 700) that detects the user input to initiate the application, and the device provides another device operational data to cause the presentation of the messaging application. For example, the wrist-wearable device 500 can detect the user input to initiate a messaging application, initiate and run the messaging application, and provide operational data to the AR device 600 and/or the HIPD 700 to cause presentation of the messaging application. Alternatively, the application can be initiated and run at a device other than the device that detected the user input. For example, the wrist-wearable device 500 can detect the hand gesture associated with initiating the messaging application and cause the HIPD 700 to run the messaging application and coordinate the presentation of the messaging application.

Further, the user 402 can provide a user input provided at the wrist-wearable device 500, the AR device 600, and/or the HIPD 700 to continue and/or complete an operation initiated at another device. For example, after initiating the messaging application via the wrist-wearable device 500 and while the AR device 600 presents the messaging user interface 412, the user 402 can provide an input at the HIPD 700 to prepare a response (e.g., shown by the swipe gesture performed on the HIPD 700). The user 402's gestures performed on the HIPD 700 can be provided and/or displayed on another device. For example, the user 402's swipe gestures performed on the HIPD 700 are displayed on a virtual keyboard of the messaging user interface 412 displayed by the AR device 600.

In some embodiments, the wrist-wearable device 500, the AR device 600, the HIPD 700, and/or other communicatively coupled devices can present one or more notifications to the user 402. The notification can be an indication of a new message, an incoming call, an application update, a status update, etc. The user 402 can select the notification via the wrist-wearable device 500, the AR device 600, or the HIPD 700 and cause presentation of an application or operation associated with the notification on at least one device. For example, the user 402 can receive a notification that a message was received at the wrist-wearable device 500, the AR device 600, the HIPD 700, and/or other communicatively coupled device and provide a user input at the wrist-wearable device 500, the AR device 600, and/or the HIPD 700 to review the notification, and the device detecting the user input can cause an application associated with the notification to be initiated and/or presented at the wrist-wearable device 500, the AR device 600, and/or the HIPD 700.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 600 can present to the user 402 game application data and the HIPD 700 can use a controller to provide inputs to the game. Similarly, the user 402 can use the wrist-wearable device 500 to initiate a camera of the AR device 600, and the user can use the wrist-wearable device 500, the AR device 600, and/or the HIPD 700 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 5A and 5B illustrate an example wrist-wearable device 500, in accordance with some embodiments. The wrist-wearable device 500 is an instance of the wrist-wearable devices 102 and 202 described in reference to FIGS. 1A-3 herein, such that the wrist-wearable devices 102 and 202 should be understood to have the features of the wrist-wearable device 500 and vice versa. FIG. 5A illustrates components of the wrist-wearable device 500, which can be used individually or in combination, including combinations that include other electronic devices and/or electronic components.

FIG. 5A shows a wearable band 510 and a watch body 520 (or capsule) being coupled, as discussed below, to form the wrist-wearable device 500. The wrist-wearable device 500 can perform various functions and/or operations associated with navigating through user interfaces and selectively opening applications, as well as the functions and/or operations described above with reference to FIGS. 1A-3.

As will be described in more detail below, operations executed by the wrist-wearable device 500 can include (i) presenting content to a user (e.g., displaying visual content via a display 505); (ii) detecting (e.g., sensing) user input (e.g., sensing a touch on peripheral button 523 and/or at a touch screen of the display 505, a hand gesture detected by sensors (e.g., biopotential sensors)); (iii) sensing biometric data via one or more sensors 513 (e.g., neuromuscular signals, heart rate, temperature, sleep, etc.); messaging (e.g., text, speech, video, etc.); image capture via one or more imaging devices or cameras 525; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 520, independently in the wearable band 510, and/or via an electronic communication between the watch body 520 and the wearable band 510. In some embodiments, functions can be executed on the wrist-wearable device 500 while an AR environment is being presented (e.g., via one of the AR systems 400a and 400b). As the skilled artisan will appreciate upon reading the descriptions provided herein, the novel wearable devices described herein can be used with other types of AR environments.

The wearable band 510 can be configured to be worn by a user such that an inner (or inside) surface of the wearable structure 511 of the wearable band 510 is in contact with the user's skin. When worn by a user, sensors 513 contact the user's skin. The sensors 513 can sense biometric data such as a user's heart rate, saturated oxygen level, temperature, sweat level, neuromuscular signal sensors, or a combination thereof. The sensors 513 can also sense data about a user's environment, including a user's motion, altitude, location, orientation, gait, acceleration, position, or a combination thereof. In some embodiments, the sensors 513 are configured to track a position and/or motion of the wearable band 510. The one or more sensors 513 can include any of the sensors defined above and/or discussed below with respect to FIG. 5B.

The one or more sensors 513 can be distributed on an inside and/or an outside surface of the wearable band 510. In some embodiments, the one or more sensors 513 are uniformly spaced along the wearable band 510. Alternatively, in some embodiments, the one or more sensors 513 are positioned at distinct points along the wearable band 510. As shown in FIG. 5A, the one or more sensors 513 can be the same or distinct. For example, in some embodiments, the one or more sensors 513 can be shaped as a pill (e.g., sensor 513a), an oval, a circle a square, an oblong (e.g., sensor 513c) and/or any other shape that maintains contact with the user's skin (e.g., such that neuromuscular signal and/or other biometric data can be accurately measured at the user's skin). In some embodiments, the one or more sensors 513 are aligned to form pairs of sensors (e.g., for sensing neuromuscular signals based on differential sensing within each respective sensor). For example, sensor 513b is aligned with an adjacent sensor to form sensor pair 514a and sensor 513d is aligned with an adjacent sensor to form sensor pair 514b. In some embodiments, the wearable band 510 does not have a sensor pair. Alternatively, in some embodiments, the wearable band 510 has a predetermined number of sensor pairs (one pair of sensors, three pairs of sensors, four pairs of sensors, six pairs of sensors, sixteen pairs of sensors, etc.).

The wearable band 510 can include any suitable number of sensors 513. In some embodiments, the number and arrangements of sensors 513 depend on the particular application for which the wearable band 510 is used. For instance, a wearable band 510 configured as an armband, wristband, or chest-band may include a plurality of sensors 513 with different number of sensors 513 and different arrangement for each use case, such as medical use cases, compared to gaming or general day-to-day use cases.

In accordance with some embodiments, the wearable band 510 further includes an electrical ground electrode and a shielding electrode. The electrical ground and shielding electrodes, like the sensors 513, can be distributed on the inside surface of the wearable band 510 such that they contact a portion of the user's skin. For example, the electrical ground and shielding electrodes can be at an inside surface of coupling mechanism 516 or an inside surface of a wearable structure 511. The electrical ground and shielding electrodes can be formed and/or use the same components as the sensors 513. In some embodiments, the wearable band 510 includes more than one electrical ground electrode and more than one shielding electrode.

The sensors 513 can be formed as part of the wearable structure 511 of the wearable band 510. In some embodiments, the sensors 513 are flush or substantially flush with the wearable structure 511 such that they do not extend beyond the surface of the wearable structure 511. While flush with the wearable structure 511, the sensors 513 are still configured to contact the user's skin (e.g., via a skin-contacting surface). Alternatively, in some embodiments, the sensors 513 extend beyond the wearable structure 511 a predetermined distance (e.g., 0.1 mm to 2 mm) to make contact and depress into the user's skin. In some embodiments, the sensors 513 are coupled to an actuator (not shown) configured to adjust an extension height (e.g., a distance from the surface of the wearable structure 511) of the sensors 513 such that the sensors 513 make contact and depress into the user's skin. In some embodiments, the actuators adjust the extension height between 0.01 mm to 1.2 mm. This allows the user to customize the positioning of the sensors 513 to improve the overall comfort of the wearable band 510 when worn while still allowing the sensors 513 to contact the user's skin. In some embodiments, the sensors 513 are indistinguishable from the wearable structure 511 when worn by the user.

The wearable structure 511 can be formed of an elastic material, elastomers, etc., configured to be stretched and fitted to be worn by the user. In some embodiments, the wearable structure 511 is a textile or woven fabric. As described above, the sensors 513 can be formed as part of a wearable structure 511. For example, the sensors 513 can be molded into the wearable structure 511 or be integrated into a woven fabric (e.g., the sensors 513 can be sewn into the fabric and mimic the pliability of fabric (e.g., the sensors 513 can be constructed from a series of woven strands of fabric)).

The wearable structure 511 can include flexible electronic connectors that interconnect the sensors 513, the electronic circuitry, and/or other electronic components (described below in reference to FIG. 5B) that are enclosed in the wearable band 510. In some embodiments, the flexible electronic connectors are configured to interconnect the sensors 513, the electronic circuitry, and/or other electronic components of the wearable band 510 with respective sensors and/or other electronic components of another electronic device (e.g., watch body 520). The flexible electronic connectors are configured to move with the wearable structure 511 such that the user adjustment to the wearable structure 511 (e.g., resizing, pulling, folding, etc.) does not stress or strain the electrical coupling of components of the wearable band 510.

As described above, the wearable band 510 is configured to be worn by a user. In particular, the wearable band 510 can be shaped or otherwise manipulated to be worn by a user. For example, the wearable band 510 can be shaped to have a substantially circular shape such that it can be configured to be worn on the user's lower arm or wrist. Alternatively, the wearable band 510 can be shaped to be worn on another body part of the user, such as the user's upper arm (e.g., around a bicep), forearm, chest, legs, etc. The wearable band 510 can include a retaining mechanism 512 (e.g., a buckle, a hook and loop fastener, etc.) for securing the wearable band 510 to the user's wrist or other body part. While the wearable band 510 is worn by the user, the sensors 513 sense data (referred to as sensor data) from the user's skin. In particular, the sensors 513 of the wearable band 510 obtain (e.g., sense and record) neuromuscular signals.

The sensed data (e.g., sensed neuromuscular signals) can be used to detect and/or determine the user's intention to perform certain motor actions. In particular, the sensors 513 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 505 of the wrist-wearable device 500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 513 can be used to provide a user with an enhanced interaction with a physical object (e.g., devices communicatively coupled with the wearable band 510) and/or a virtual object in an artificial-reality application generated by an artificial-reality system (e.g., user interface objects presented on the display 505 or another computing device (e.g., a smartphone)).

In some embodiments, the wearable band 510 includes one or more haptic devices 546 (FIG. 5B; e.g., a vibratory haptic actuator) that are configured to provide haptic feedback (e.g., a cutaneous and/or kinesthetic sensation, etc.) to the user's skin. The sensors 513, and/or the haptic devices 546 can be configured to operate in conjunction with multiple applications including, without limitation, health monitoring, social media, games, and artificial reality (e.g., the applications associated with artificial reality).

The wearable band 510 can also include coupling mechanism 516 (e.g., a cradle or a shape of the coupling mechanism can correspond to shape of the watch body 520 of the wrist-wearable device 500) for detachably coupling a capsule (e.g., a computing unit) or watch body 520 (via a coupling surface of the watch body 520) to the wearable band 510. In particular, the coupling mechanism 516 can be configured to receive a coupling surface proximate to the bottom side of the watch body 520 (e.g., a side opposite to a front side of the watch body 520 where the display 505 is located), such that a user can push the watch body 520 downward into the coupling mechanism 516 to attach the watch body 520 to the coupling mechanism 516. In some embodiments, the coupling mechanism 516 can be configured to receive a top side of the watch body 520 (e.g., a side proximate to the front side of the watch body 520 where the display 505 is located) that is pushed upward into the cradle, as opposed to being pushed downward into the coupling mechanism 516. In some embodiments, the coupling mechanism 516 is an integrated component of the wearable band 510 such that the wearable band 510 and the coupling mechanism 516 are a single unitary structure. In some embodiments, the coupling mechanism 516 is a type of frame or shell that allows the watch body 520 coupling surface to be retained within or on the wearable band 510 coupling mechanism 516 (e.g., a cradle, a tracker band, a support base, a clasp, etc.).

The coupling mechanism 516 can allow for the watch body 520 to be detachably coupled to the wearable band 510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 520 to the wearable band 510 and to decouple the watch body 520 from the wearable band 510. For example, a user can twist, slide, turn, push, pull, or rotate the watch body 520 relative to the wearable band 510, or a combination thereof, to attach the watch body 520 to the wearable band 510 and to detach the watch body 520 from the wearable band 510. Alternatively, as discussed below, in some embodiments, the watch body 520 can be decoupled from the wearable band 510 by actuation of the release mechanism 529.

The wearable band 510 can be coupled with a watch body 520 to increase the functionality of the wearable band 510 (e.g., converting the wearable band 510 into a wrist-wearable device 500, adding an additional computing unit and/or battery to increase computational resources and/or a battery life of the wearable band 510, adding additional sensors to improve sensed data, etc.). As described above, the wearable band 510 (and the coupling mechanism 516) is configured to operate independently (e.g., execute functions independently) from watch body 520. For example, the coupling mechanism 516 can include one or more sensors 513 that contact a user's skin when the wearable band 510 is worn by the user and provide sensor data for determining control commands.

A user can detach the watch body 520 (or capsule) from the wearable band 510 in order to reduce the encumbrance of the wrist-wearable device 500 to the user. For embodiments in which the watch body 520 is removable, the watch body 520 can be referred to as a removable structure, such that in these embodiments the wrist-wearable device 500 includes a wearable portion (e.g., the wearable band 510) and a removable structure (the watch body 520).

Turning to the watch body 520, the watch body 520 can have a substantially rectangular or circular shape. The watch body 520 is configured to be worn by the user on their wrist or on another body part. More specifically, the watch body 520 is sized to be easily carried by the user, attached on a portion of the user's clothing, and/or coupled to the wearable band 510 (forming the wrist-wearable device 500). As described above, the watch body 520 can have a shape corresponding to the coupling mechanism 516 of the wearable band 510. In some embodiments, the watch body 520 includes a single release mechanism 529 or multiple release mechanisms (e.g., two release mechanisms 529 positioned on opposing sides of the watch body 520, such as spring-loaded buttons) for decoupling the watch body 520 and the wearable band 510. The release mechanism 529 can include, without limitation, a button, a knob, a plunger, a handle, a lever, a fastener, a clasp, a dial, a latch, or a combination thereof.

A user can actuate the release mechanism 529 by pushing, turning, lifting, depressing, shifting, or performing other actions on the release mechanism 529. Actuation of the release mechanism 529 can release (e.g., decouple) the watch body 520 from the coupling mechanism 516 of the wearable band 510, allowing the user to use the watch body 520 independently from wearable band 510, and vice versa. For example, decoupling the watch body 520 from the wearable band 510 can allow the user to capture images using rear-facing camera 525B. Although the coupling mechanism 516 is shown positioned at a corner of watch body 520, the release mechanism 529 can be positioned anywhere on watch body 520 that is convenient for the user to actuate. In addition, in some embodiments, the wearable band 510 can also include a respective release mechanism for decoupling the watch body 520 from the coupling mechanism 516. In some embodiments, the release mechanism 529 is optional and the watch body 520 can be decoupled from the coupling mechanism 516 as described above (e.g., via twisting, rotating, etc.).

The watch body 520 can include one or more peripheral buttons 523 and 527 for performing various operations at the watch body 520. For example, the peripheral buttons 523 and 527 can be used to turn on or wake (e.g., transition from a sleep state to an active state) the display 505, unlock the watch body 520, increase or decrease a volume, increase or decrease brightness, interact with one or more applications, interact with one or more user interfaces, etc. Additionally, or alternatively, in some embodiments, the display 505 operates as a touch screen and allows the user to provide one or more inputs for interacting with the watch body 520.

In some embodiments, the watch body 520 includes one or more sensors 521. The sensors 521 of the watch body 520 can be the same or distinct from the sensors 513 of the wearable band 510. The sensors 521 of the watch body 520 can be distributed on an inside and/or an outside surface of the watch body 520. In some embodiments, the sensors 521 are configured to contact a user's skin when the watch body 520 is worn by the user. For example, the sensors 521 can be placed on the bottom side of the watch body 520 and the coupling mechanism 516 can be a cradle with an opening that allows the bottom side of the watch body 520 to directly contact the user's skin. Alternatively, in some embodiments, the watch body 520 does not include sensors that are configured to contact the user's skin (e.g., including sensors internal and/or external to the watch body 520 that configured to sense data of the watch body 520 and the watch body 520's surrounding environment). In some embodiments, the sensors 513 are configured to track a position and/or motion of the watch body 520.

The watch body 520 and the wearable band 510 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 520 and the wearable band 510 can share data sensed by the sensors 513 and 521, as well as application-and device-specific information (e.g., active and/or available applications), output devices (e.g., display, speakers, etc.), input devices (e.g., touch screen, microphone, imaging sensors, etc.).

In some embodiments, the watch body 520 can include, without limitation, a front-facing camera 525A and/or a rear-facing camera 525B, sensors 521 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 563; FIG. 5B), a touch sensor, a sweat sensor, etc.). In some embodiments, the watch body 520 can include one or more haptic devices 576 (FIG. 5B; a vibratory haptic actuator) that is configured to provide haptic feedback (e.g., a cutaneous and/or kinesthetic sensation, etc.) to the user. The sensors 521 and/or the haptic device 576 can also be configured to operate in conjunction with multiple applications including, without limitation, health-monitoring applications, social media applications, game applications, and artificial-reality applications (e.g., the applications associated with artificial reality).

As described above, the watch body 520 and the wearable band 510, when coupled, can form the wrist-wearable device 500. When coupled, the watch body 520 and wearable band 510 operate as a single device to execute functions (operations, detections, communications, etc.) described herein. In some embodiments, each device is provided with particular instructions for performing the one or more operations of the wrist-wearable device 500. For example, in accordance with a determination that the watch body 520 does not include neuromuscular signal sensors, the wearable band 510 can include alternative instructions for performing associated instructions (e.g., providing sensed neuromuscular signal data to the watch body 520 via a different electronic device). Operations of the wrist-wearable device 500 can be performed by the watch body 520 alone or in conjunction with the wearable band 510 (e.g., via respective processors and/or hardware components) and vice versa. In some embodiments, operations of the wrist-wearable device 500, the watch body 520, and/or the wearable band 510 can be performed in conjunction with one or more processors and/or hardware components of another communicatively coupled device (e.g., the HIPD 700; FIGS. 7A-7B).

As described below with reference to the block diagram of FIG. 5B, the wearable band 510 and/or the watch body 520 can each include independent resources required to independently execute functions. For example, the wearable band 510 and/or the watch body 520 can each include a power source (e.g., a battery), a memory, data storage, a processor (e.g., a central processing unit (CPU)), communications, a light source, and/or input/output devices.

FIG. 5B shows block diagrams of a computing system 530 corresponding to the wearable band 510, and a computing system 560 corresponding to the watch body 520, according to some embodiments. A computing system of the wrist-wearable device 500 includes a combination of components of the wearable band computing system 530 and the watch body computing system 560, in accordance with some embodiments.

The watch body 520 and/or the wearable band 510 can include one or more components shown in watch body computing system 560. In some embodiments, a single integrated circuit includes all or a substantial portion of the components of the watch body computing system 560 are included in a single integrated circuit. Alternatively, in some embodiments, components of the watch body computing system 560 are included in a plurality of integrated circuits that are communicatively coupled. In some embodiments, the watch body computing system 560 is configured to couple (e.g., via a wired or wireless connection) with the wearable band computing system 530, which allows the computing systems to share components, distribute tasks, and/or perform other operations described herein (individually or as a single device).

The watch body computing system 560 can include one or more processors 579, a controller 577, a peripherals interface 561, a power system 595, and memory (e.g., a memory 580), each of which are defined above and described in more detail below.

The power system 595 can include a charger input 596, a power-management integrated circuit (PMIC) 597, and a battery 598, each are which are defined above. In some embodiments, a watch body 520 and a wearable band 510 can have respective charger inputs (e.g., charger input 596 and 557), respective batteries (e.g., battery 598 and 559), and can share power with each other (e.g., the watch body 520 can power and/or charge the wearable band 510, and vice versa). Although watch body 520 and/or the wearable band 510 can include respective charger inputs, a single charger input can charge both devices when coupled. The watch body 520 and the wearable band 510 can receive a charge using a variety of techniques. In some embodiments, the watch body 520 and the wearable band 510 can use a wired charging assembly (e.g., power cords) to receive the charge. Alternatively, or in addition, the watch body 520 and/or the wearable band 510 can be configured for wireless charging. For example, a portable charging device can be designed to mate with a portion of watch body 520 and/or wearable band 510 and wirelessly deliver usable power to a battery of watch body 520 and/or wearable band 510. The watch body 520 and the wearable band 510 can have independent power systems (e.g., power system 595 and 556) to enable each to operate independently. The watch body 520 and wearable band 510 can also share power (e.g., one can charge the other) via respective PMICs (e.g., PMICs 597 and 558) that can share power over power and ground conductors and/or over wireless charging antennas.

In some embodiments, the peripherals interface 561 can include one or more sensors 521, many of which listed below are defined above. The sensors 521 can include one or more coupling sensors 562 for detecting when the watch body 520 is coupled with another electronic device (e.g., a wearable band 510). The sensors 521 can include imaging sensors 563 (one or more of the cameras 525 and/or separate imaging sensors 563 (e.g., thermal-imaging sensors)). In some embodiments, the sensors 521 include one or more SpO2 sensors 564. In some embodiments, the sensors 521 include one or more biopotential-signal sensors (e.g., EMG sensors 565, which may be disposed on a user-facing portion of the watch body 520 and/or the wearable band 510). In some embodiments, the sensors 521 include one or more capacitive sensors 566. In some embodiments, the sensors 521 include one or more heart rate sensors 567. In some embodiments, the sensors 521 include one or more IMUs 568. In some embodiments, one or more IMUs 568 can be configured to detect movement of a user's hand or other location that the watch body 520 is placed or held.

In some embodiments, the peripherals interface 561 includes an NFC component 569, a global-position system (GPS) component 570, a long-term evolution (LTE) component 571, and/or a Wi-Fi and/or Bluetooth communication component 572. In some embodiments, the peripherals interface 561 includes one or more buttons 573 (e.g., the peripheral buttons 523 and 527 in FIG. 5A), which, when selected by a user, cause operations to be performed at the watch body 520. In some embodiments, the peripherals interface 561 includes one or more indicators, such as a light emitting diode (LED), to provide a user with visual indicators (e.g., message received, low battery, an active microphone, and/or a camera, etc.).

The watch body 520 can include at least one display 505 for displaying visual representations of information or data to the user, including user-interface elements and/or three-dimensional (3D) virtual objects. The display can also include a touch screen for inputting user inputs, such as touch gestures, swipe gestures, and the like. The watch body 520 can include at least one speaker 574 and at least one microphone 575 for providing audio signals to the user and receiving audio input from the user. The user can provide user inputs through the microphone 575 and can also receive audio output from the speaker 574 as part of a haptic event provided by the haptic controller 578. The watch body 520 can include at least one camera 525, including a front-facing camera 525A and a rear-facing camera 525B. The cameras 525 can include ultra-wide-angle cameras, wide-angle cameras, fish-eye cameras, spherical cameras, telephoto cameras, a depth-sensing cameras, or other types of cameras.

The watch body computing system 560 can include one or more haptic controllers 578 and associated componentry (e.g., haptic devices 576) for providing haptic events at the watch body 520 (e.g., a vibrating sensation or audio output in response to an event at the watch body 520). The haptic controllers 578 can communicate with one or more haptic devices 576, such as electroacoustic devices, including a speaker of the one or more speakers 574 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 578 can provide haptic events to respective haptic actuators that are capable of being sensed by a user of the watch body 520. In some embodiments, the one or more haptic controllers 578 can receive input signals from an application of the applications 582.

In some embodiments, the computer system 530 and/or the computer system 560 can include memory 580, which can be controlled by a memory controller of the one or more controllers 577 and/or one or more processors 579. In some embodiments, software components stored in the memory 580 include one or more applications 582 configured to perform operations at the watch body 520. In some embodiments, the one or more applications 582 include games, word processors, messaging applications, calling applications, web browsers, social media applications, media streaming applications, financial applications, calendars, clocks, etc. In some embodiments, software components stored in the memory 580 include one or more communication interface modules 583 as defined above. In some embodiments, software components stored in the memory 580 include one or more graphics modules 584 for rendering, encoding, and/or decoding audio and/or visual data; and one or more data management modules 585 for collecting, organizing, and/or providing access to the data 587 stored in memory 580. In some embodiments, software components stored in the memory 580 include a mini-app management module 586A, which is configured to perform the features described above in reference to FIGS. 1A-3. In some embodiments, one or more of applications 582 and/or one or more modules can work in conjunction with one another to perform various tasks at the watch body 520.

In some embodiments, software components stored in the memory 580 can include one or more operating systems 581 (e.g., a Linux-based operating system, an Android operating system, etc.). The memory 580 can also include data 587. The data 587 can include profile data 588A, sensor data 589A, media content data 590, application data 591, and precondition monitoring data 592A, which stores data related to the performance of the features described above in reference to FIGS. 1A-3.

It should be appreciated that the watch body computing system 560 is an example of a computing system within the watch body 520, and that the watch body 520 can have more or fewer components than shown in the watch body computing system 560, combine two or more components, and/or have a different configuration and/or arrangement of the components. The various components shown in watch body computing system 560 are implemented in hardware, software, firmware, or a combination thereof, including one or more signal processing and/or application-specific integrated circuits.

Turning to the wearable band computing system 530, one or more components that can be included in the wearable band 510 are shown. The wearable band computing system 530 can include more or fewer components than shown in the watch body computing system 560, combine two or more components, and/or have a different configuration and/or arrangement of some or all of the components. In some embodiments, all, or a substantial portion of the components of the wearable band computing system 530 are included in a single integrated circuit. Alternatively, in some embodiments, components of the wearable band computing system 530 are included in a plurality of integrated circuits that are communicatively coupled. As described above, in some embodiments, the wearable band computing system 530 is configured to couple (e.g., via a wired or wireless connection) with the watch body computing system 560, which allows the computing systems to share components, distribute tasks, and/or perform other operations described herein (individually or as a single device).

The wearable band computing system 530, similar to the watch body computing system 560, can include one or more processors 549, one or more controllers 547 (including one or more haptics controller 548), a peripherals interface 531 that can include one or more sensors 513 and other peripheral devices, power source (e.g., a power system 556), and memory (e.g., a memory 550) that includes an operating system (e.g., an operating system 551), data (e.g., data 554 including profile data 588B, sensor data 589B, precondition monitoring data 592B, etc.), and one or more modules (e.g., a communications interface module 552, a data management module 553, a mini-app management module 586B, etc.).

The one or more sensors 513 can be analogous to sensors 521 of the computer system 560 in light of the definitions above. For example, sensors 513 can include one or more coupling sensors 532, one or more SpO2 sensors 534, one or more EMG sensors 535, one or more capacitive sensors 536, one or more heart rate sensors 537, and one or more IMU sensors 538.

The peripherals interface 531 can also include other components analogous to those included in the peripheral interface 561 of the computer system 560, including an NFC component 539, a GPS component 540, an LTE component 541, a Wi-Fi and/or Bluetooth communication component 542, and/or one or more haptic devices 576 as described above in reference to peripherals interface 561. In some embodiments, the peripherals interface 531 includes one or more buttons 543, a display 533, a speaker 544, a microphone 545, and a camera 555. In some embodiments, the peripherals interface 531 includes one or more indicators, such as an LED.

It should be appreciated that the wearable band computing system 530 is an example of a computing system within the wearable band 510, and that the wearable band 510 can have more or fewer components than shown in the wearable band computing system 530, combine two or more components, and/or have a different configuration and/or arrangement of the components. The various components shown in wearable band computing system 530 can be implemented in one or a combination of hardware, software, and firmware, including one or more signal processing and/or application-specific integrated circuits.

The wrist-wearable device 500 with respect to FIGS. 5A is an example of the wearable band 510 and the watch body 520 coupled, so the wrist-wearable device 500 will be understood to include the components shown and described for the wearable band computing system 530 and the watch body computing system 560. In some embodiments, wrist-wearable device 500 has a split architecture (e.g., a split mechanical architecture or a split electrical architecture) between the watch body 520 and the wearable band 510. In other words, all of the components shown in the wearable band computing system 530 and the watch body computing system 560 can be housed or otherwise disposed in a combined watch device 500, or within individual components of the watch body 520, wearable band 510, and/or portions thereof (e.g., a coupling mechanism 516 of the wearable band 510).

The techniques described above can be used with any device for sensing neuromuscular signals, including the arm-wearable devices of FIG. 5A-5B, but could also be used with other types of wearable devices for sensing neuromuscular signals (such as body-wearable or head-wearable devices that might have neuromuscular sensors closer to the brain or spinal column).

In some embodiments, a wrist-wearable device 500 can be used in conjunction with a head-wearable device described below (e.g., AR device 600 and VR device 610) and/or an HIPD 700, and the wrist-wearable device 500 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable device, attention will now be turned to example head-wearable devices, such AR device 600 and VR device 610.

### Example Head-Wearable Devices

FIGS. 6A-6C show example head-wearable devices, in accordance with some embodiments. Head-wearable devices can include, but are not limited to, AR devices 610 (e.g., AR or smart eyewear devices, such as smart glasses, smart monocles, smart contacts, etc.), VR devices 610 (e.g., VR headsets, head-mounted displays (HMD)s, etc.), or other ocularly coupled devices. The AR devices 600 and the VR devices 610 are instances of the head-wearable devices 104 and 204 described in reference to FIGS. 1A-2M herein, such that the head-wearable device should be understood to have the features of the AR devices 600 and/or the VR devices 610, and vice versa. The AR devices 600 and the VR devices 610 can perform various functions and/or operations associated with navigating through user interfaces and selectively opening applications, as well as the functions and/or operations described above with reference to FIGS. 1A-3.

In some embodiments, an AR system (e.g., AR 400a and 400b; FIGS. 4A and 4B) includes an AR device 600 (as shown in FIG. 6A) and/or VR device 610 (as shown in FIGS. 6B-1-B-2). In some embodiments, the AR device 600 and the VR device 610 can include one or more analogous components (e.g., components for presenting interactive artificial-reality environments, such as processors, memory, and/or presentation devices, including one or more displays and/or one or more waveguides), some of which are described in more detail with respect to FIG. 6C. The head-wearable devices can use display projectors (e.g., display projector assemblies 607A and 607B) and/or waveguides for projecting representations of data to a user. Some embodiments of head-wearable devices do not include displays.

FIG. 6A shows an example visual depiction of the AR device 600 (e.g., which may also be described herein as augmented-reality glasses and/or smart glasses). The AR device 600 can work in conjunction with additional electronic components that are not shown in FIGS. 6A, such as a wearable accessory device and/or an intermediary processing device, in electronic communication or otherwise configured to be used in conjunction with the AR device 600. In some embodiments, the wearable accessory device and/or the intermediary processing device may be configured to couple with the AR device 600 via a coupling mechanism in electronic communication with a coupling sensor 624, where the coupling sensor 624 can detect when an electronic device becomes physically or electronically coupled with the AR device 600. In some embodiments, the AR device 600 can be configured to couple to a housing (e.g., a portion of frame 604 or temple arms 605), which may include one or more additional coupling mechanisms configured to couple with additional accessory devices. The components shown in FIG. 6A can be implemented in hardware, software, firmware, or a combination thereof, including one or more signal-processing components and/or application-specific integrated circuits (ASICs).

The AR device 600 includes mechanical glasses components, including a frame 604 configured to hold one or more lenses (e.g., one or both lenses 606-1 and 606-2). One of ordinary skill in the art will appreciate that the AR device 600 can include additional mechanical components, such as hinges configured to allow portions of the frame 604 of the AR device 600 to be folded and unfolded, a bridge configured to span the gap between the lenses 606-1 and 606-2 and rest on the user's nose, nose pads configured to rest on the bridge of the nose and provide support for the AR device 600, earpieces configured to rest on the user's ears and provide additional support for the AR device 600, temple arms 605 configured to extend from the hinges to the earpieces of the AR device 600, and the like. One of ordinary skill in the art will further appreciate that some examples of the AR device 600 can include none of the mechanical components described herein. For example, smart contact lenses configured to present artificial-reality to users may not include any components of the AR device 600.

The lenses 606-1 and 606-2 can be individual displays or display devices (e.g., a waveguide for projected representations). The lenses 606-1 and 606-2 may act together or independently to present an image or series of images to a user. In some embodiments, the lenses 606-1 and 606-2 can operate in conjunction with one or more display projector assemblies 607A and 607B to present image data to a user. While the AR device 600 includes two displays, embodiments of this disclosure may be implemented in AR devices with a single near-eye display (NED) or more than two NEDs.

The AR device 600 includes electronic components, many of which will be described in more detail below with respect to FIG. 6C. Some example electronic components are illustrated in FIG. 6A, including sensors 623-1, 623-2, 623-3,. 623-4, 623-5, and 623-6, which can be distributed along a substantial portion of the frame 604 of the AR device 600. The different types of sensors are described below in reference to FIG. 6C. The AR device 600 also includes a left camera 639A and a right camera 639B, which are located on different sides of the frame 604. And the eyewear device includes one or more processors 648A and 648B (e.g., an integral microprocessor, such as an ASIC) that is embedded into a portion of the frame 604.

FIGS. 6B-1 and 6B-2 show an example visual depiction of the VR device 610 (e.g., a head-mounted display (HMD) 612, also referred to herein as an artificial-reality headset, a head-wearable device, a VR headset, etc.). The HMD 612 includes a front body 614 and a frame 616 (e.g., a strap or band) shaped to fit around a user's head. In some embodiments, the front body 614 and/or the frame 616 includes one or more electronic elements for facilitating presentation of and/or interactions with an AR and/or VR system (e.g., displays, processors (e.g., processor 648A-1), IMUs, tracking emitter or detectors, sensors, etc.). In some embodiments, the HMD 612 includes output audio transducers (e.g., an audio transducer 618-1), as shown in FIG. 6B-2. In some embodiments, one or more components, such as the output audio transducer(s) 618-1 and the frame 616, can be configured to attach and detach (e.g., are detachably attachable) to the HMD 612 (e.g., a portion or all of the frame 616, and/or the output audio transducer 618-1), as shown in FIG. 6B-2. In some embodiments, coupling a detachable component to the HMD 612 causes the detachable component to come into electronic communication with the HMD 612. The VR device 610 includes electronic components, many of which will be described in more detail below with respect to FIG. 6C

FIG. 6B-1 to 6B-2 also show that the VR device 610 one or more cameras, such as the left camera 639A and the right camera 639B, which can be analogous to the left and right cameras on the frame 604 of the AR device 600. In some embodiments, the VR device 610 includes one or more additional cameras (e.g., cameras 639C and 639D), which can be configured to augment image data obtained by the cameras 639A and 639B by providing more information. For example, the camera 639C can be used to supply color information that is not discerned by cameras 639A and 639B. In some embodiments, one or more of the cameras 639A to 639D can include an optional IR cut filter configured to remove IR light from being received at the respective camera sensors.

The VR device 610 can include a housing 690 storing one or more components of the VR device 610 and/or additional components of the VR device 610. The housing 690 can be a modular electronic device configured to couple with the VR device 610 (or an AR device 600) and supplement and/or extend the capabilities of the VR device 610 (or an AR device 600). For example, the housing 690 can include additional sensors, cameras, power sources, processors (e.g., processor 648A-2), etc. to improve and/or increase the functionality of the VR device 610. Examples of the different components included in the housing 690 are described below in reference to FIG. 6C.

Alternatively or in addition, in some embodiments, the head-wearable device, such as the VR device 610 and/or the AR device 600), includes, or is communicatively coupled to, another external device (e.g., a paired device), such as an HIPD 700 (discussed below in reference to FIGS. 7A-7B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 700, an optional neckband, and/or wearable accessory device) with the head-wearable devices (e.g., an AR device 600 and/or VR device 610) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 700) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 700, can process information generated by one or more sensors of its sensors and/or information provided by other communicatively coupled devices. For example, a head-wearable device can include an IMU, and the intermediary processing device (neckband and/or an HIPD 700) can compute all inertial and spatial calculations from the IMUs located on the head-wearable device. Additional examples of processing performed by a communicatively coupled device, such as the HIPD 700, are provided below in reference to FIGS. 7A and 7B.

Artificial-reality systems may include a variety of types of visual feedback mechanisms. For example, display devices in the AR devices 600 and/or the VR devices 610 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 600 and/or the VR device 610 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 600 and the VR device 610, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 600 and/or the VR device 610 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 500, an HIPD 700, smart textile-based garment (not shown), etc.), and/or other devices described herein.

FIG. 6C illustrates a computing system 620 and an optional housing 690, each of which show components that can be included in a head-wearable device (e.g., the AR device 600 and/or the VR device 610). In some embodiments, more or less components can be included in the optional housing 690 depending on practical restraints of the respective head-wearable device being described. Additionally or alternatively, the optional housing 690 can include additional components to expand and/or augment the functionality of a head-wearable device.

In some embodiments, the computing system 620 and/or the optional housing 690 can include one or more peripheral interfaces 622A and 622B, one or more power systems 642A and 642B (including charger input 643, PMIC 644, and battery 645), one or more controllers 646A 646B (including one or more haptic controllers 647), one or more processors 648A and 648B (as defined above, including any of the examples provided), and memory 650A and 650B, which can all be in electronic communication with each other. For example, the one or more processors 648A and/or 648B can be configured to execute instructions stored in the memory 650A and/or 650B, which can cause a controller of the one or more controllers 646A and/or 646B to cause operations to be performed at one or more peripheral devices of the peripherals interfaces 622A and/or 622B. In some embodiments, each operation described can occur based on electrical power provided by the power system 642A and/or 642B.

In some embodiments, the peripherals interface 622A can include one or more devices configured to be part of the computing system 620, many of which have been defined above and/or described with respect to wrist-wearable devices shown in FIGS. 5A and 5B. For example, the peripherals interface can include one or more sensors 623A. Some example sensors include: one or more coupling sensors 624, one or more acoustic sensors 625, one or more imaging sensors 626, one or more EMG sensors 627, one or more capacitive sensors 628, and/or one or more IMUs 629. In some embodiments, the sensors 623A further include depth sensors 667, light sensors 668 and/or any other types of sensors defined above or described with respect to any other embodiments discussed herein.

In some embodiments, the peripherals interface can include one or more additional peripheral devices, including one or more NFC devices 630, one or more GPS devices 631, one or more LTE devices 632, one or more WiFi and/or Bluetooth devices 633, one or more buttons 634 (e.g., including buttons that are slidable or otherwise adjustable), one or more displays 635A, one or more speakers 636A, one or more microphones 637A, one or more cameras 638A (e.g., including the a first camera 639-1 through nth camera 639-n, which are analogous to the left camera 639A and/or the right camera 639B), one or more haptic devices 640; and/or any other types of peripheral devices defined above or described with respect to any other embodiments discussed herein.

The head-wearable devices can include a variety of types of visual feedback mechanisms (e.g., presentation devices). For example, display devices in the AR device 600 and/or the VR device 610 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 635A can be coupled to each of the lenses 606-1 and 606-2 of the AR device 600. The displays 635A coupled to each of the lenses 606-1 and 606-2 can act together or independently to present an image or series of images to a user. In some embodiments, the AR device 600 and/or the VR device 610 includes a single display 635A (e.g., a near-eye display) or more than two displays 635A.

In some embodiments, a first set of one or more displays 635A can be used to present an augmented-reality environment, and a second set of one or more display devices 635A can be used to present a virtual-reality environment. In some embodiments, one or more waveguides are used in conjunction with presenting artificial-reality content to the user of the AR device 600 and/or the VR device 610 (e.g., as a means of delivering light from a display projector assembly and/or one or more displays 635A to the user's eyes). In some embodiments, one or more waveguides are fully or partially integrated into the AR device 600 and/or the VR device 610. Additionally, or alternatively to display screens, some artificial-reality systems include one or more projection systems. For example, display devices in the AR device 600 and/or the VR device 610 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 635A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 635A for presenting information to users. For example, an external display 635A can be used to show a current battery level, network activity (e.g., connected, disconnected, etc.), current activity (e.g., playing a game, in a call, in a meeting, watching a movie, etc.), and/or other relevant information. In some embodiments, the external displays 635A can be used to communicate with others. For example, a user of the head-wearable device can cause the external displays 635A to present a do not disturb notification. The external displays 635A can also be used by the user to share any information captured by the one or more components of the peripherals interface 622A and/or generated by head-wearable device (e.g., during operation and/or performance of one or more applications).

The memory 650A can include instructions and/or data executable by one or more processors 648A (and/or processors 648B of the housing 690) and/or a memory controller of the one or more controllers 646A (and/or controller 646B of the housing 690). The memory 650A can include one or more operating systems 651; one or more applications 652; one or more communication interface modules 653A; one or more graphics modules 654A; one or more AR processing modules 655A; a mini-app management module 656 (analogous to mini-app management module 586; FIG. 5B); and/or any other types of modules or components defined above or described with respect to any other embodiments discussed herein.

The data 660 stored in memory 650A can be used in conjunction with one or more of the applications and/or programs discussed above. The data 660 can include profile data 661; sensor data 662; media content data 663; AR application data 664; precondition monitoring data 665 (analogous to mini-app management module 592; FIG. 5B); and/or any other types of data defined above or described with respect to any other embodiments discussed herein.

In some embodiments, the controller 646A of the head-wearable devices processes information generated by the sensors 623A on the head-wearable devices and/or another component of the head-wearable devices and/or communicatively coupled with the head-wearable devices (e.g., components of the housing 690, such as components of peripherals interface 622B). For example, the controller 646A can process information from the acoustic sensors 625 and/or image sensors 626. For each detected sound, the controller 646A can perform a direction of arrival (DOA) estimation to estimate a direction from which the detected sound arrived at a head-wearable device. As one or more of the acoustic sensors 625 detects sounds, the controller 646A can populate an audio data set with the information (e.g., represented by sensor data 662).

In some embodiments, a physical electronic connector can convey information between the head-wearable devices and another electronic device, and/or between one or more processors 648A of the head-wearable devices and the controller 646A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 700) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 600 and/or the VR device 610 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 6B-1 and 6B-2 show the VR device 610 having cameras 639A-639D, which can be used to provide depth information for creating a voxel field and a two-dimensional mesh to provide object information to the user to avoid collisions.

The optional housing 690 can include analogous components to those describe above with respect to the computing system 620. For example, the optional housing 690 can include a respective peripherals interface 622B including more or less components to those described above with respect to the peripherals interface 622A. As described above, the components of the optional housing 690 can be used augment and/or expand on the functionality of the head-wearable devices. For example, the optional housing 690 can include respective sensors 623B, speakers 636B, displays 635B, microphones 637B, cameras 638B, and/or other components to capture and/or present data. Similarly, the optional housing 690 can include one or more processors 648B, controllers 646B, and/or memory 650B (including respective communication interface modules 653B; one or more graphics modules 654B; one or more AR processing modules 655B, etc.) that can be used individually and/or in conjunction with the components of the computing system 620.

The techniques described above in FIGS. 6A-6C can be used with different head-wearable devices. In some embodiments, the head-wearable devices (e.g., the AR device 600 and/or the VR device 610) can be used in conjunction with one or more wearable device such as a wrist-wearable device 500 (or components thereof), as well as an HIPD 700. Having thus described example the head-wearable devices, attention will now be turned to example handheld intermediary processing devices, such as HIPD 700.

### Example Handheld Intermediary Processing Devices

FIGS. 7A and 7B illustrate an example handheld intermediary processing device (HIPD) 700, in accordance with some embodiments. The HIPD 700 is an instance of the intermediary device described in reference to FIG. 3 herein, such that the HIPD 700 should be understood to have the features described with respect to any intermediary device defined above or otherwise described herein, and vice versa. The HIPD 700 can perform various functions and/or operations associated with navigating through user interfaces and selectively opening applications, as well as the functions and/or operations described above with reference to FIGS. 1A-3.

FIG. 7A shows a top view 705 and a side view 725 of the HIPD 700. The HIPD 700 is configured to communicatively couple with one or more wearable devices (or other electronic devices) associated with a user. For example, the HIPD 700 is configured to communicatively couple with a user's wrist-wearable device 500 (or components thereof, such as the watch body 520 and the wearable band 510), AR device 600, and/or VR device 610. The HIPD 700 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 700 can successfully be communicatively coupled with an electronic device, such as a wearable device).

The HIPD 700 can perform various functions independently and/or in conjunction with one or more wearable devices (e.g., wrist-wearable device 500, AR device 600, VR device 610, etc.). The HIPD 700 is configured to increase and/or improve the functionality of communicatively coupled devices, such as the wearable devices. The HIPD 700 is configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-3.

Additionally, as will be described in more detail below, functionality and/or operations of the HIPD 700 can include, without limitation, task offloading and/or handoffs; thermals offloading and/or handoffs; 6 degrees of freedom (6DoF) raycasting and/or gaming (e.g., using imaging devices or cameras 714A and 714B, which can be used for simultaneous localization and mapping (SLAM) and/or with other image processing techniques); portable charging; messaging; image capturing via one or more imaging devices or cameras (e.g., cameras 722A and 722B); sensing user input (e.g., sensing a touch on a multi-touch input surface 702); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 700 and/or in communication between the HIPD 700 and another wearable device described herein. In some embodiments, functions can be executed on the HIPD 700 in conjunction with an AR environment. As the skilled artisan will appreciate upon reading the descriptions provided herein, the novel the HIPD 700 described herein can be used with any type of suitable AR environment.

While the HIPD 700 is communicatively coupled with a wearable device and/or other electronic device, the HIPD 700 is configured to perform one or more operations initiated at the wearable device and/or the other electronic device. In particular, one or more operations of the wearable device and/or the other electronic device can be offloaded to the HIPD 700 to be performed. The HIPD 700 performs the one or more operations of the wearable device and/or the other electronic device and provides to data corresponded to the completed operations to the wearable device and/or the other electronic device. For example, a user can initiate a video stream using AR device 600 and back-end tasks associated with performing the video stream (e.g., video rendering) can be offloaded to the HIPD 700, which the HIPD 700 performs and provides corresponding data to the AR device 600 to perform remaining front-end tasks associated with the video stream (e.g., presenting the rendered video data via a display of the AR device 600). In this way, the HIPD 700, which has more computational resources and greater thermal headroom than a wearable device, can perform computationally intensive tasks for the wearable device improving performance of an operation performed by the wearable device.

The HIPD 700 includes a multi-touch input surface 702 on a first side (e.g., a front surface) that is configured to detect one or more user inputs. In particular, the multi-touch input surface 702 can detect single tap inputs, multi-tap inputs, swipe gestures and/or inputs, force-based and/or pressure-based touch inputs, held taps, and the like. The multi-touch input surface 702 is configured to detect capacitive touch inputs and/or force (and/or pressure) touch inputs. The multi-touch input surface 702 includes a first touch-input surface 704 defined by a surface depression, and a second touch-input surface 706 defined by a substantially planar portion. The first touch-input surface 704 can be disposed adjacent to the second touch-input surface 706. In some embodiments, the first touch-input surface 704 and the second touch-input surface 706 can be different dimensions, shapes, and/or cover different portions of the multi-touch input surface 702. For example, the first touch-input surface 704 can be substantially circular and the second touch-input surface 706 is substantially rectangular. In some embodiments, the surface depression of the multi-touch input surface 702 is configured to guide user handling of the HIPD 700. In particular, the surface depression is configured such that the user holds the HIPD 700 upright when held in a single hand (e.g., such that the using imaging devices or cameras 714A and 714B are pointed toward a ceiling or the sky). Additionally, the surface depression is configured such that the user's thumb rests within the first touch-input surface 704.

In some embodiments, the different touch-input surfaces include a plurality of touch-input zones. For example, the second touch-input surface 706 includes at least a first touch-input zone 708 within a second touch-input zone 706 and a third touch-input zone 710 within the first touch-input zone 708. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 708 causes the HIPD 700 to perform a first command and a user input detected within the second touch-input zone 706 causes the HIPD 700 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 708 can be configured to detect force touch inputs (e.g., a magnitude at which the user presses down) and capacitive touch inputs, and the second touch-input zone 706 can be configured to detect capacitive touch inputs.

The HIPD 700 includes one or more sensors 751 for sensing data used in the performance of one or more operations and/or functions. For example, the HIPD 700 can include an IMU that is used in conjunction with cameras 714 for 3-dimensional object manipulation (e.g., enlarging, moving, destroying, etc. an object) in an AR or VR environment. Non-limiting examples of the sensors 751 included in the HIPD 700 include a light sensor, a magnetometer, a depth sensor, a pressure sensor, and a force sensor. Additional examples of the sensors 751 are provided below in reference to FIG. 7B.

The HIPD 700 can include one or more light indicators 712 to provide one or more notifications to the user. In some embodiments, the light indicators are LEDs or other types of illumination devices. The light indicators 712 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 704. The light indicators can be illuminated in different colors and/or patterns to provide the user with one or more notifications and/or information about the device. For example, a light indicator positioned around the first touch-input surface 704 can flash when the user receives a notification (e.g., a message), change red when the HIPD 700 is out of power, operate as a progress bar (e.g., a light ring that is closed when a task is completed (e.g., 0% to 100%)), operates as a volume indicator, etc.).

In some embodiments, the HIPD 700 includes one or more additional sensors on another surface. For example, as shown FIG. 7A, HIPD 700 includes a set of one or more sensors (e.g., sensor set 720) on an edge of the HIPD 700. The sensor set 720, when positioned on an edge of the of the HIPD 700, can be pe positioned at a predetermined tilt angle (e.g., 26 degrees), which allows the sensor set 720 to be angled toward the user when placed on a desk or other flat surface. Alternatively, in some embodiments, the sensor set 720 is positioned on a surface opposite the multi-touch input surface 702 (e.g., a back surface). The one or more sensors of the sensor set 720 are discussed in detail below.

The side view 725 of the of the HIPD 700 shows the sensor set 720 and camera 714B. The sensor set 720 includes one or more cameras 722A and 722B, a depth projector 724, an ambient light sensor 728, and a depth receiver 730. In some embodiments, the sensor set 720 includes a light indicator 726. The light indicator 726 can operate as a privacy indicator to let the user and/or those around them know that a camera and/or microphone is active. The sensor set 720 is configured to capture a user's facial expression such that the user can puppet a custom avatar (e.g., showing emotions, such as smiles, laughter, etc., on the avatar or a digital representation of the user). The sensor set 720 can be configured as a side stereo RGB system, a rear indirect Time-of-Flight (iToF) system, or a rear stereo RGB system. As the skilled artisan will appreciate upon reading the descriptions provided herein, the novel HIPD 700 described herein can use different sensor set 720 configurations and/or sensor set 720 placement.

In some embodiments, the HIPD 700 includes one or more haptic devices 771 (FIG. 7B; e.g., a vibratory haptic actuator) that are configured to provide haptic feedback (e.g., kinesthetic sensation). The sensors 751, and/or the haptic devices 771 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 700 is configured to operate without a display. However, in optional embodiments, the HIPD 700 can include a display 768 (FIG. 7B). The HIPD 700 can also income one or more optional peripheral buttons 767 (FIG. 7B). For example, the peripheral buttons 767 can be used to turn on or turn off the HIPD 700. Further, the HIPD 700 housing can be formed of polymers and/or elastomer elastomers. The HIPD 700 can be configured to have a non-slip surface to allow the HIPD 700 to be placed on a surface without requiring a user to watch over the HIPD 700. In other words, the HIPD 700 is designed such that it would not easily slide off a surfaces. In some embodiments, the HIPD 700 include one or magnets to couple the HIPD 700 to another surface. This allows the user to mount the HIPD 700 to different surfaces and provide the user with greater flexibility in use of the HIPD 700.

As described above, the HIPD 700 can distribute and/or provide instructions for performing the one or more tasks at the HIPD 700 and/or a communicatively coupled device. For example, the HIPD 700 can identify one or more back-end tasks to be performed by the HIPD 700 and one or more front-end tasks to be performed by a communicatively coupled device. While the HIPD 700 is configured to offload and/or handoff tasks of a communicatively coupled device, the HIPD 700 can perform both back-end and front-end tasks (e.g., via one or more processors, such as CPU 777; FIG. 7B). The HIPD 700 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 700 can perform the above operations alone or in conjunction with a wearable device (or other communicatively coupled electronic device).

FIG. 7B shows block diagrams of a computing system 740 of the HIPD 700, in accordance with some embodiments. The HIPD 700, described in detail above, can include one or more components shown in HIPD computing system 740. The HIPD 700 will be understood to include the components shown and described below for the HIPD computing system 740. In some embodiments, all, or a substantial portion of the components of the HIPD computing system 740 are included in a single integrated circuit. Alternatively, in some embodiments, components of the HIPD computing system 740 are included in a plurality of integrated circuits that are communicatively coupled.

The HIPD computing system 740 can include a processor (e.g., a CPU 777, a GPU, and/or a CPU with integrated graphics), a controller 775, a peripherals interface 750 that includes one or more sensors 751 and other peripheral devices, a power source (e.g., a power system 795), and memory (e.g., a memory 778) that includes an operating system (e.g., an operating system 779), data (e.g., data 788), one or more applications (e.g., applications 780), and one or more modules (e.g., a communications interface module 781, a graphics module 782, a task and processing management module 783, an interoperability module 784, an AR processing module 785, a data management module 786, a mini-app management module 787, etc.). The HIPD computing system 740 further includes a power system 795 that includes a charger input and output 796, a PMIC 797, and a battery 798, all of which are defined above.

In some embodiments, the peripherals interface 750 can include one or more sensors 751. The sensors 751 can include analogous sensors to those described above in reference to FIGS. 5B. For example, the sensors 751 can include imaging sensors 754, (optional) EMG sensors 756, IMUs 758, and capacitive sensors 760. In some embodiments, the sensors 751 can include one or more pressure sensor 752 for sensing pressure data, an altimeter 753 for sensing an altitude of the HIPD 700, a magnetometer 755 for sensing a magnetic field, a depth sensor 757 (or a time-of flight sensor) for determining a difference between the camera and the subject of an image, a position sensor 759 (e.g., a flexible position sensor) for sensing a relative displacement or position change of a portion of the HIPD 700, a force sensor 761 for sensing a force applied to a portion of the HIPD 700, and a light sensor 762 (e.g., an ambient light sensor) for detecting an amount of lighting. The sensors 751 can include one or more sensors not shown in FIG. 7B.

Analogous to the peripherals described above in reference to FIGS. 5B, the peripherals interface 750 can also include an NFC component 763, a GPS component 764, an LTE component 765, a Wi-Fi and/or Bluetooth communication component 766, a speaker 769, a haptic device 771, and a microphone 773. As described above in reference to FIG. 7A, the HIPD 700 can optionally include a display 768 and/or one or more buttons 767. The peripherals interface 750 can further include one or more cameras 770, touch surfaces 772, and/or one or more light emitters 774. The multi-touch input surface 702 described above in reference to FIG. 7A is an example of touch surface 772. The light emitters 774 can be one or more LEDs, lasers, etc. and can be used to project or present information to a user. For example, the light emitters 774 can include light indicators 712 and 726 described above in reference to FIG. 7A. The cameras 770 (e.g., cameras 714A, 714B, and 722 described above in FIG. 7A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 770 can be used for SLAM; 6 DoF ray casting, gaming, object manipulation, and/or other rendering; facial recognition and facial expression recognition, etc.

Similar to the watch body computing system 560 and the watch band computing system 530 described above in reference to FIG. 5B, the HIPD computing system 740 can include one or more haptic controllers 776 and associated componentry (e.g., haptic devices 771) for providing haptic events at the HIPD 700.

Memory 778 can include high-speed random-access memory and/or non-volatile memory, such as one or more magnetic disk storage devices, flash memory devices, or other non-volatile solid-state memory devices. Access to the memory 778 by other components of the HIPD 700, such as the one or more processors and the peripherals interface 750, can be controlled by a memory controller of the controllers 775.

In some embodiments, software components stored in the memory 778 include one or more operating systems 779, one or more applications 780, one or more communication interface modules 781, one or more graphics modules 782, one or more data management modules 785, which are analogous to the software components described above in reference to FIG. 5B. The software components stored in the memory 778 can also include a mini-app management module 786 (analogous to mini-app management module 586; FIG. 5B).

In some embodiments, software components stored in the memory 778 include a task and processing management module 783 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 783 uses data 788 (e.g., device data 790) to distribute the one or more front-end and/or back-end tasks based on communicatively coupled devices' computing resources, available power, thermal headroom, ongoing operations, and/or other factors. For example, the task and processing management module 783 can cause the performance of one or more back-end tasks (of an operation performed at communicatively coupled AR device 600) at the HIPD 700 in accordance with a determination that the operation is utilizing a predetermined amount (e.g., at least 70%) of computing resources available at the AR device 600.

In some embodiments, software components stored in the memory 778 include an interoperability module 784 for exchanging and utilizing information received and/or provided to distinct communicatively coupled devices. The interoperability module 784 allows for different systems, devices, and/or applications to connect and communicate in a coordinated way without user input. In some embodiments, software components stored in the memory 778 include an AR module 785 that is configured to process signals based at least on sensor data for use in an AR and/or VR environment. For example, the AR processing module 785 can be used for 3D object manipulation, gesture recognition, facial and facial expression, recognition, etc.

The memory 778 can also include data 787, including structured data. In some embodiments, the data 787 can include profile data 789, device data 789 (including device data of one or more devices communicatively coupled with the HIPD 700, such as device type, hardware, software, configurations, etc.), sensor data 791, media content data 792, application data 793, and precondition monitoring data 794 (analogous to mini-app management module 592; FIG. 5B).

It should be appreciated that the HIPD computing system 740 is an example of a computing system within the HIPD 700, and that the HIPD 700 can have more or fewer components than shown in the HIPD computing system 740, combine two or more components, and/or have a different configuration and/or arrangement of the components. The various components shown in HIPD computing system 740 are implemented in hardware, software, firmware, or a combination thereof, including one or more signal processing and/or application-specific integrated circuits.

The techniques described above in FIG. 7A-7B can be used with any device used as a human-machine interface controller. In some embodiments, an HIPD 700 can be used in conjunction with one or more wearable device such as a head-wearable device (e.g., AR device 600 and VR device 610) and/or a wrist-wearable device 500 (or components thereof).

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt-in or opt-out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including instructions that, when executed by a wrist-wearable device worn by a user, cause the wrist-wearable device to:
install data to enable use of an operation on the wrist-wearable device only while an operation-use precondition is present, the operation-use precondition being specifically associated with the operation;
while the operation-use precondition is present, enable use of the operation on the wrist-wearable device; and
in accordance with determining that the operation-use precondition is no longer present:
automatically, without instructions from the user of the wrist-wearable device, remove at least some of the data from the wrist-wearable device to make the operation unavailable on the wrist-wearable device.

2. The non-transitory, computer-readable storage medium of claim 1, wherein the installing is initiated at the wrist-wearable device without any interaction by the user with a touch-sensitive display of the wrist-wearable device.

3. The non-transitory, computer-readable storage medium of claim 1, wherein:
the operation-use precondition includes one of:
a biometric-authentication precondition requiring that the user is wearing the wrist-wearable device for the operation to remain enabled such that if the user is determined, based on operation-use condition data at the wrist-wearable device, to no longer be wearing the wrist-wearable device, then the operation-use precondition is no longer present,
and the operation-use precondition further includes one or more of:
a duration precondition defining a predetermined period after the installing during which the operation is made available to the user;
a physical-activity-based precondition that is present while the user is performing a physical activity, the physical activity being specifically associated with the operation; and
a location-based precondition that is present while the user is determined to be within a physical area associated with use of the operation.

4. The non-transitory, computer-readable storage medium of claim 1, wherein:
the installing is performed in response to detecting, via one or more sensors that are electronically coupled with the wrist-wearable device, a gesture performed by the user within a threshold distance of a physical beacon.

5. The non-transitory, computer-readable storage medium of claim 1, wherein the installing is performed based on one or both of (i) obtaining data from a QR code and (ii) obtaining data from a near-field communication (NFC) signal.

6. The non-transitory, computer-readable storage medium of claim 1, wherein the instructions, when executed by the wrist-wearable device, further cause the wrist-wearable device to:
in conjunction with enabling use of the operation on the wrist-wearable device and in accordance with a determination that the operation requires image data, activate a camera that is in communication with the wrist-wearable device; and
while the operation-use precondition is present, and the camera is activated:
based on detecting, using image data from the camera, an identifier corresponding to a physical item, cause display of data related to the physical item.

7. The non-transitory, computer-readable storage medium of claim 6, wherein the instructions, when executed by the wrist-wearable device, further cause the wrist-wearable device to:
while the data about the physical item is caused to be displayed:
in accordance with determining that the user has provided a gesture-based indication or a location-based indication requesting to add the physical item to an item listing, add the physical item to the item listing.

8. The non-transitory, computer-readable storage medium of claim 1, wherein the instructions, when executed by the wrist-wearable device, further cause the wrist-wearable device to:
in accordance with determining that the operation-use precondition is no longer present:
notify the user that the operation is no longer available on the wrist-wearable device because the operation-use precondition is no longer present; and
notify the user to retain physical possession of each physical item on the item listing.

9. The non-transitory, computer-readable storage medium of claim 1, wherein:
the installing is performed in accordance with a determination that a component of the wrist-wearable device has been approved for access to a limited-access event; and
the data to enable use of the operation is associated with gaining access to the limited-access event by causing the wrist-wearable device to present an access information item to obtain access to the limited-access event.

10. The non-transitory, computer-readable storage medium of claim 9, wherein:
the access information item to obtain access to the limited-access event indicates one of a plurality of access levels associated with the component of the wrist-wearable device.

11. The non-transitory, computer-readable storage medium of claim 1, wherein:
the operation corresponds to a waitlist for performing an activity at a physical area; and
without providing a phone number directly to an organizer of the activity, receive a message, via the data to enable use of the operation, wherein the message is associated with a time for gaining access to the activity off of the waitlist.

12. The non-transitory, computer-readable storage medium of claim 11, wherein the instructions, when executed by the wrist-wearable device, further cause the wrist-wearable device to:
in conjunction with enabling use of the operation on the wrist-wearable device and in accordance with a determination that the operation requires scheduling data for the user, permit access to data associated with a calendar application,
wherein a time period for gaining access to the activity corresponding to the waitlist is determined based in part on the scheduling data for the user.

13. The non-transitory, computer-readable storage medium of claim 1, wherein the instructions, when executed by the wrist-wearable device, further cause the wrist-wearable device to:
after installing the data to enable use of the operation, displaying, at the display of the wrist-wearable device, a visually-perceptible element of an application corresponding to the operation, wherein the application is not otherwise available at the wrist-wearable device; and
the application corresponding to the operation is not downloaded at the wrist-wearable device.

14. The non-transitory, computer-readable storage medium of claim 1, wherein:
the operation corresponds to a third-party application; and
the user is able to cause the operation to be performed without having an account associated with the third-party application.

15. The non-transitory, computer-readable storage medium of claim 1, wherein the removing at least some of the data from the wrist-wearable device to make the operation unavailable on the wrist-wearable device comprises removing all of the data from the wrist-wearable device.

16. The non-transitory, computer-readable storage medium of claim 1, wherein the data to enable use of the operation on the wrist-wearable device only while the operation-use precondition has an associated file size of less than one hundred megabytes.

17. The non-transitory, computer-readable storage medium of claim 16, wherein the associated file size is less than fifty megabytes.

18. A method of temporarily enabling use of an operation for access at a wrist-wearable device, comprising:
installing, on a wrist-wearable device worn by a user, data to enable use of an operation on the wrist-wearable device only while an operation-use precondition is present, the operation-use precondition being specifically associated with the operation;
while the operation-use precondition is present, enabling use of the operation on the wrist-wearable device; and
in accordance with determining that the operation-use precondition is no longer present:
automatically, without instructions from the user of the wrist-wearable device, removing at least some of the data from the wrist-wearable device to make the operation unavailable on the wrist-wearable device.

19. The method of claim 18, wherein the installing is initiated at the wrist-wearable device without any interaction by the user with a touch-sensitive display of the wrist-wearable device.

20. A wrist-wearable device, comprising:
a display;
one or more sensors; and
memory storing one or more programs that, when executed by one or more processors of the of the wearable device, cause the performance of:
installing, on a wrist-wearable device worn by a user, data to enable use of an operation on the wrist-wearable device only while an operation-use precondition is present, the operation-use precondition being specifically associated with the operation,
while the operation-use precondition is present, enabling use of the operation on the wrist-wearable device, and
in accordance with determining that the operation-use precondition is no longer present:
automatically, without instructions from the user of the wrist-wearable device, removing at least some of the data from the wrist-wearable device to make the operation unavailable on the wrist-wearable device.
